(19) United States
(12) Patent Application Publication
(10) Pub. No.: US 2020/0015311 A1
(43) Pub. Date: Jan. 9, 2020

(54) METHOD FOR PROCESSING NAS MESSAGE IN WIRELESS COMMUNICATION SYSTEM AND APPARATUS FOR SAME

(71) Applicant: LG Electronics Inc., Seoul (KR)

(72) Inventor: Taehun KIM, Seoul (KR)

(21) Appl. No.: 16/490,197

(22) PCT Filed: Mar. 20, 2018
(86) PCT No.: PCT/KR2018/003221

§ 371 Date: Aug. 30, 2019

Related U.S. Application Data
(60) Provisional application No. 62/473,488, filed on Mar. 20, 2017.
(60) Provisional application No. 62/521,544, filed on Jun. 19, 2017.
(60) Provisional application No. 62/581,784, filed on Nov. 6, 2017.

(51) Int. Cl. H04W 76/25; H04W 8/08; H04W 68/00; H04W 76/11; H04W 28/04

(52) U.S. Cl. CPC H04W 76/25; H04W 8/08; H04W 28/04; H04W 76/11; H04W 68/005

(57) ABSTRACT

Disclosed are a method for processing a NAS message in a wireless communication system and an apparatus for the same. Specifically, a method for processing a non-access stratum (NAS) message by an access and mobility management function (AMF) in a wireless communication system may include: receiving, from a user equipment (UE), an uplink (UL) NAS transport message including an uplink message; and when the uplink message is not successfully transported to a network function (NF), transmitting, to the UE, a first downlink (DL) NAS transport message indicating that the uplink message is not transported.

### CROSS-REFERENCE TO RELATED APPLICATIONS

This application is the National Stage filing under 35 U.S.C. 371 of International Application No. PCT/KR2018/003221, filed on Mar. 20, 2018, which claims the benefit of U.S. Provisional Application No. 62/473,488, filed on Mar. 20, 2017, No. 62/521,544, filed on Jun. 19, 2017, No. 62/581,784, filed on Nov. 6, 2017, the contents of which are all hereby incorporated by reference herein in their entirety.

### TECHNICAL FIELD

The present invention relates to a wireless communication system, and more particularly, to a method for processing a non-access stratum (NAS) message and an apparatus for supporting the same.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive Multiple Input Multiple Output (MIMO), in-band full duplex, non-orthogonal multiple access (NOMA), supporting super-wide band, and device networking, have been researched.

### DISCLOSURE

### Technical Problem

An object of the present invention is to provide a method for processing a NAS message.

In particular, an object of the present invention is to provide a method for processing a NAS message in abnormal cases in a network.

The technical objects of the present invention are not limited to the aforementioned technical objects, and other technical objects, which are not mentioned above, will be apparently appreciated by a person having ordinary skill in the art from the following description.

### Technical Solution

In an aspect, a method for processing a non-access stratum (NAS) message by an access and mobility management function (AMF) in a wireless communication system may include: receiving, from a user equipment (UE), an uplink (UL) NAS transport message including an uplink message; and when the uplink message is not successfully transported to a network function (NF), transmitting, to the UE, a first downlink (DL) NAS transport message including a cause indicating that the uplink message is not transported.

In another aspect, an access and mobility management function (AMF) apparatus for processing a non-access stratum (NAS) message in a wireless communication system may include: a communication module transmitting and receiving a wired/wireless signal; and a processor controlling the communication module, in which the processor may be configured to receive, from user equipment (UE), an uplink (UL) NAS transport message including an uplink message, and when the uplink message is not successfully transported to a network function (NF), transmit, to the UE, a first downlink (DL) NAS transport message including a cause indicating that the uplink message is not transported.

Preferably, the first DL NAS transport message may further include a PDU session identifier (ID) for identifying a protocol data unit (PDU) session.

Preferably, the method may further include transmitting the uplink message to the NF, in which when a response to the uplink message is not received from the NF, it may be determined that the uplink message is not successfully transported.

Preferably, the method may further include starting a timer when transmitting the uplink message to the NF, in which when the response to the uplink message is not received from the NF until the timer expires, it may be determined that the uplink message is not successfully transported.

Preferably, when the UL NAS transport message includes an indication that the NF needs to provide the response to the uplink message, the AMF may wait for the response to the uplink message from the NF.

Preferably, if it is determined that transportation of the uplink message to the NF is not required, the transportation of the uplink message to the NF may not be attempted and it may be determined that the uplink message is not successfully transported, and the reason why the transportation of the uplink message is not required may include a case where the NF is in a congestion state, a case where the NF does not normally operate, and a case where an appropriate NF for transporting the uplink message does not exist.

Preferably, the method may further include transmitting, to the UE, a second DL NAS transport message including a downlink message from the NF to the UE, in which if the downlink message includes an indication that the response to the downlink message is requested from the UE, the AMF may encapsulate an indication that the UE needs to provide the response to the downlink message in the second DL NAS transport message.

Preferably, the uplink message may be the response to the downlink message.

### Advantageous Effects

According to an embodiment of the present invention, in an abnormal case, a NAS message can be explicitly processed in a UE and a network.

Further, according to an embodiment of the present invention, a signaling load for processing the NAS message between the UE and the network can be reduced in the abnormal case.

In addition, according to an embodiment of the present invention, a burden of storing the NAS message can be reduced in the network in order to prepare for the abnormal case.

Advantages which can be obtained in the present invention are not limited to the aforementioned effects and other unmentioned advantages will be clearly understood by those skilled in the art from the following description.

### Description of Drawings

In order to help understanding of the present invention, the accompanying drawings which are included as a part of the Detailed Description provide embodiments of the present invention and describe the technical features of the present invention together with the Detailed Description.

FIGS. 1 to 8 illustrate a wireless communication system architecture to which the present invention may be applied.

FIG. 9 illustrates an NG-RAN architecture to which the present invention may be applied.

FIG. 10 is a diagram illustrating a radio protocol stack in a wireless communication system to which the present invention may be applied.

FIG. 11 illustrates an MO SMS procedure over NAS in a wireless communication system to which the present invention may be applied.

FIG. 12 illustrates an MO SMS procedure using a one step approach in CM-IDLE in a wireless communication system to which the present invention may be applied.

FIG. 13 illustrates a NAS transport including SM and another service in a wireless communication system to which the present invention may be applied.

FIG. 14 illustrates a NAS transport including SM signaling in a wireless communication system to which the present invention may be applied.

FIG. 15 illustrates a NAS transport for SM, SMS, and another service in a wireless communication system to which the present invention may be applied.

FIG. 16 illustrates an NAS transport procedure originated by a UE when the UE is in a CM-CONNECTED mode in a wireless communication system to which the present invention may be applied.

FIG. 17 illustrates a two step NAS transport procedure originated by a UE when the UE is in CM-IDLE in a wireless communication system to which the present invention may be applied.

FIG. 18 illustrates a one step NAS transport procedure originated by a UE when the UE is in CM-IDLE in a wireless communication system to which the present invention may be applied.

FIG. 19 illustrates an NAS transport procedure originated by a network when a UE is in CM-CONNECTED mode in a wireless communication system to which the present invention may be applied.

FIG. 20 illustrates an MT SMS procedure over NAS in a wireless communication system to which the present invention may be applied.

FIG. 21 is a diagram illustrating a 5GMM status procedure in a wireless communication system to which the present invention may be applied.

FIGS. 22 to 25 are diagrams illustrating an NAS transport procedure according to an embodiment of the present invention.

FIG. 26 illustrates a block diagram of a communication apparatus according to an embodiment of the present invention.

FIG. 27 illustrates a block diagram of a communication apparatus according to an embodiment of the present invention.

### MODE FOR INVENTION

In what follows, preferred embodiments according to the present invention will be described in detail with reference to appended drawings. The detailed descriptions provided below together with appended drawings are intended only to explain illustrative embodiments of the present invention, which should not be regarded as the sole embodiments of the present invention. The detailed descriptions below include specific information to provide complete understanding of the present invention. However, those skilled in the art will be able to comprehend that the present invention can be embodied without the specific information.

For some cases, to avoid obscuring the technical principles of the present invention, structures and devices well-known to the public can be omitted or can be illustrated in the form of block diagrams utilizing fundamental functions of the structures and the devices.

A base station in this document is regarded as a terminal node of a network, which performs communication directly with a UE. In this document, particular operations regarded to be performed by the base station may be performed by an upper node of the base station depending on situations. In other words, it is apparent that in a network consisting of a plurality of network nodes including a base station, various operations performed for communication with a UE can be performed by the base station or by network nodes other than the base station. The term Base Station (BS) can be replaced with a fixed station, Node B, evolved-NodeB (eNB), Base Transceiver System (BTS), or Access Point (AP). Also, a terminal can be fixed or mobile; and the term can be replaced with User Equipment (UE), Mobile Station (MS), User Terminal (UT), Mobile Subscriber Station (MSS), Subscriber Station (SS), Advanced Mobile Station (AMS), Wireless Terminal (WT), Machine-Type Communication (MTC) device, Machine-to-Machine (M2M) device, or Device-to-Device (D2D) device.

In what follows, downlink (DL) refers to communication from a base station to a terminal, while uplink (UL) refers to communication from a terminal to a base station. In downlink transmission, a transmitter can be part of the base station, and a receiver can be part of the terminal. Similarly, in uplink transmission, a transmitter can be part of the terminal, and a receiver can be part of the base station.

Specific terms used in the following descriptions are introduced to help understanding the present invention, and the specific terms can be used in different ways as long as it does not leave the technical scope of the present invention.

Embodiments of the present invention can be supported by standard documents disclosed in at least one of wireless access systems including the IEEE 802, 3GPP, and 3GPP2 specifications. In other words, among the embodiments of the present invention, those steps or parts omitted for the purpose of clearly describing technical principles of the present invention can be supported by the documents above. Also, all of the terms disclosed in this document can be explained with reference to the standard documents.

To clarify the descriptions, this document is based on the 3GPP 5G (5 Generation) system, but the technical features of the present invention are not limited to the current descriptions.

Terms used in this document are defined as follows.

Evolved Packet System (EPS): a network system including an Evolved Packet Core (EPC), that is an Internet Protocol (IP) based packet switched core network, and an access network such as LTE and UTRAN. The EPS is a network of an evolved version of a Universal Mobile Telecommunications System (UMTS).

eNodeB: a base station of an EPS network. The eNodeB is installed outdoor, and its coverage has a scale of a macro cell.

International Mobile Subscriber Identity (IMSI): an internationally unique subscriber identity allocated in a mobile communication network.

Public Land Mobile Network (PLMN): a network configured for the purpose of providing mobile communication services to individuals. The PLMN can be configured for each operator.

5G system (5GS): a system composed of a 5G Access Network (AN), a 5G core network and a User Equipment (UE).

5G Access Network (5G-AN) (or AN): an access network composed of a New Generation Radio Access Network (NG-RAN) and/or a non-3GPP Access Network (AN) connected to the 5G core network.

New Generation Radio Access Network (NG-RAN) (or RAN): a Radio Access Network having a common feature of being connected to 5GC and supporting one or more of the following options:

1) Standalone New Radio.

2) New radio that is an anchor supporting E-UTRA extension.

3) Standalone E-UTRA (for example, eNodeB).

4) Anchor supporting new radio extension

5G Core Network (5GC): a core network connected to a 5G access network.

Network Function (NF): means a processing function adopted in 3GPP within a network or defined in 3GPP. The processing function includes a defined functional behavior and an interface defined in 3GPP.

NF service: a function exposed by the NF via a service-based interface and consumed by other authenticated NF(s).

Network Slice: a logical network that provides specific network capability(s) and network feature(s).

Network Slice instance: a set of NF instance(s) and required resources(s) (e.g., compute, storage, and networking resources) that form a deployed network slice.

Protocol Data Unit (PDU) Connectivity Service: service providing the exchange of PDU(s) between the UE and a data network.

PDU Connectivity Service: service providing the exchange of PDU(s) between the UE and a data network.

PDU Session: association between the UE and the data network providing the PDU Connectivity Service. An association type may be Internet Protocol (IP), Ethernet, or unstructured.

Non-Access Stratum (NAS): a functional layer for transceiving signaling and a traffic message between the UE and the core network in EPS and 5GS protocol stack. The NAS mainly functions to support mobility of the UE and support a session management procedure.

5G system Architecture to Which Present Invention is Applicable

A 5G system as a technology evolved from a 4-th generation mobile communication technology supports a new radio access technology (RAT), extended (LTE) (eLTE) as an extended technology long term evolution (LTE), non-3GPP (for example, wireless local area network (WLAN)) access, and the like through evolution of the existing mobile communication network or a clean-state structure.

A 5G system architecture is defined to support data connection and service so that deployment uses technologies such as network function virtualization and software defined networking. The 5G system architecture utilizes service-based interactions between control plane (CP) network functions (NFs). Several primary principles and concepts are as follows.

CP functions and user plane (UP) functions are distinguished and independent scalability, evolution, and flexible deployments (e.g., centralized location or distributed (remote) location) are permitted.

Function designing is modularized (e.g., flexible and efficient network slicing is enabled)

Procedures (i.e., set of interactions between the NFs) are defined to be applied even anywhere as services

If necessary, each NF may directly interact with another NF The architecture does not exclude use of an intermediate function so as to route a control plane message

Dependency between an access network (AN) and a core network (CN) is minimized. The architecture is defined as a converged core network having a common AN-CN interface integrating different access types (e.g., 3GPP access and non-3GPP access).

An integrated authentication framework is supported

“Stateless” NFs are supported in which a “compute” resource is separated from a “storage” resource

Capability extension is supported

Concurrent access to local and centralized services is supported. UP functions may be deployed close to the access network in order to support low latency services and the access to a local data network

Roaming for both local breakout (LBO) traffic and home routed traffic in visited PLMN is supported

The 5G system may be defined based on the service and an interaction between network functions (NFs) in the architecture for the 5G system may be presented by two following schemes.

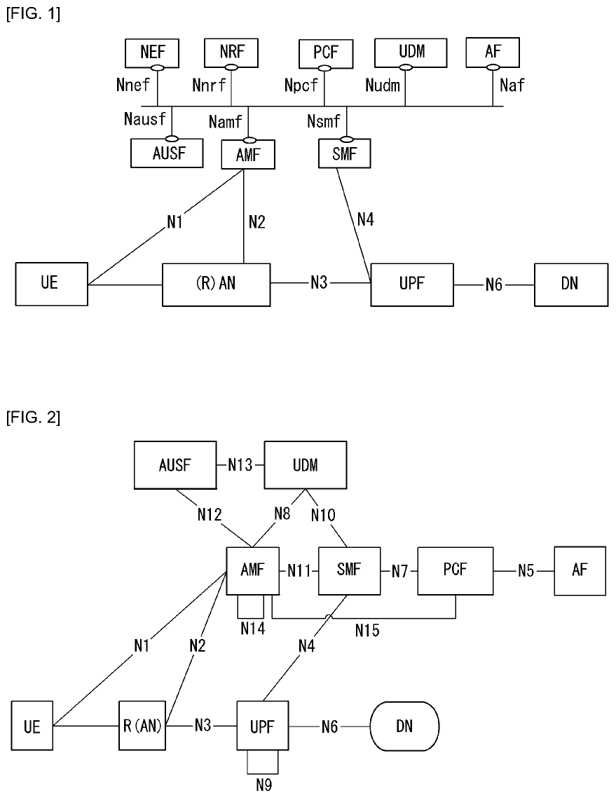

Service-based representation (FIG. 1): Network functions (e.g., AMF) in the control plane (CP) permit other authenticated network functions to access services thereof. The representation also includes a point-to-point reference point.

Reference point representation (FIG. 2): Represents the interaction between the NF services in the NFs described by the point-to-point reference point (e.g., N11) between two NFs (e.g., AMF and SMF).

FIG. 1 illustrates a wireless communication system architecture to which the present invention may be applied.

A service-based interface illustrated in FIG. 1 represents a set of services provided/exposed by a predetermined NF. The service-based interface is used in the control plane.

Referring to FIG. 1, a 5G system architecture may include various components (i.e., network functions (NFs)). FIG. 1 illustrates some of the various components including an Authentication Server Function (AUSF), a (Core) Access and Mobility Management Function (AMF), a Session Management Function (SMF), a Policy Control function (PCF), an Application Function (AF), a Unified Data Management (UDM), Data network (DN), User plane Function (UPF), a (Radio) Access Network ((R)AN), and a User Equipment (UE).

Respective NFs support the following functions.

The AUSF stores data for the authentication of the UE.

The AMF provides a function for the connection and mobility management for each UE, and one AMF can be basically connected to one UE.

More specifically, the AMF supports functions of inter-CN node signaling for mobility between 3GPP access networks, termination of RAN CP interface (i.e., N2 interface), termination N1 of NAS signaling, NAS signaling security (NAS ciphering and integrity protection), AS security control, registration management (registration area management), connection management, idle mode UE reachability (including control and execution of paging retransmission), mobility management control (subscription and policy), support of intra-system mobility and inter-system mobility, support of network slicing, SMF selection, lawful intercept (for an interface to AMF event and L1 system), providing the delivery of a session management (SM) message between UE and SMF, transparent proxy for routing the SM message, access authentication, access authorization including roaming authority check, providing the delivery of a SMS message between UE and SMSF, Security Anchor Function (SEA), Security Context Management (SCM), and the like.

Some or all of the functions of the AMF can be supported in a single instance of one AMF.

The DN means, for example, operator services, internet access, or 3rd party service. The DN transmits a downlink Protocol Data Unit (PDU) to the UPF or receives the PDU transmitted from the UE from the UPF.

The PCF receives information about packet flow from an application server and provides functions of determining policies such as mobility management and session management. More specifically, the PCF supports functions of supporting a unified policy framework for controlling a network operation, providing a policy rule so that CP function(s) (e.g., AMF, SMF, etc.) can enforce the policy rule, and implementing a front end for accessing related subscription information for policy decision in a User Data Repository (UDR).

The SMF provides a session management function. If the UE has a plurality of sessions, the sessions can be respectively managed by different SMFs.

More specifically, the SMF supports functions of session management (e.g., session establishment, modification, and release, including tunnel maintenance between the UPF and the AN node), UE IP address allocation and management (including optional authentication), selection and control of UP function, configuring traffic steering at UPF to route traffic to proper destination, termination of interfaces toward policy control functions, enforcement of control part of a policy and QoS, lawful intercept (for an interface to SM event and L1 system), termination of SM part of a NAS message, downlink data notification, an initiator of AN specific SM information (sent to AN via the AMF over N2), SSC mode decision of the session, a roaming function, and the like.

Some or all of the functions of the SMF can be supported in a single instance of one SMF.

The UDM stores subscription data of user, policy data, etc. The UDM includes two parts, i.e., application front end (FE) and User Data Repository (UDR).

The FE includes UDM FE taking charge of location management, subscription management, processing of credential, etc. and PCF taking charge of policy control. The UDR stores data required for functions provided by the UDM-FE and a policy profile required by the PCF. Data stored in the UDR includes user subscription data including subscription identifier, security credential, access and mobility related subscription data, and session related subscription data and policy data. The UDM-FE accesses subscription information stored in the UDR and supports functions of Authentication Credential Processing, User Identification Handling, access authentication, registration/mobility management, subscription management, SMS management, and the like.

The UPF transmits the downlink PDU received from the DN to the UE via the (R)AN and transmits the uplink PDU received from the UE to the DN via the (R)AN.

More specifically, the UPF supports functions of anchor point for intra/inter RAT mobility, external PDU session point of interconnect to Data Network (DN), packet routing and forwarding, packet inspection and user plane part of policy rule enforcement, lawful intercept, reporting of traffic usage, uplink classifier to support routing traffic flow to Data Network (DN), branching point to support multi-homed PDU session, QoS handling (e.g., packet filtering, gating, uplink/downlink rate enforcement) for user plane, uplink traffic verification (SDF mapping between Service Data Flow (SDF) and QoS flow), transport level packet marking in the uplink and downlink, downlink packet buffering and downlink data notification triggering, and the like. Some or all of the functions of the UPF can be supported in a single instance of one UPF.

AF interacts with 3GPP core network to provide services (e.g., support functions of an application influence on traffic routing, network capability exposure access, interaction with policy framework for policy control, and the like).

The NEF provides a means to securely expose services and capabilities provided by 3GPP network functions, for example, 3rd party, internal exposure/re-exposure, application function, and edge computing. The NEF receives information from other network function(s) (based on exposed capabilities of other network function(s)). The NEF can store the received information as structured data using a standardized interface to a data storage network function. The stored information can be re-exposed by the NEF to other network functions and other application functions and can be used for other purposes such as analytics.

The NRF supports a service discovery function. The NRF receives NF Discovery Request from NF instance and provides information of the discovered NF instance to the NF instance. The NRF also maintains available NF instances and their supported services.

(R)AN collectively refers to a new radio access network supporting both evolved E-UTRA, that is an evolved version of 4G radio access technology, and a New Radio (NR) access technology (e.g., gNB).

A gNB supports functions of radio resource management function (i.e., radio bearer control, radio admission control, connection mobility control, dynamic allocation of resources to the UE in uplink/downlink (scheduling)), Internet Protocol (IP) header compression, encryption of user data stream and integrity protection, selection of AMF upon attachment of the UE if routing to the AMF is not determined from information provided to the UE, routing of user plane data to UPF(s), routing of control plane information to ANF, connection setup and release, scheduling and transmission of a paging message (generated from the AMF), scheduling and transmission of system broadcast information (generated from the AMF or operating and maintenance (O&M)), measurement and measurement reporting configuration for mobility and scheduling, transport level packet marking in uplink, session management, support of network slicing, QoS flow management and mapping to data radio bearer, support of a UE in an inactive mode, NAS message distribution function, NAS node selection function, radio access network sharing, dual connectivity, tight interworking between NR and E-UTRA, and the like.

The UE means a user equipment. The user equipment may be referred to as a term such as a terminal, a mobile equipment (ME), and a mobile station (MS). The user equipment may be a portable device such as a notebook computer, a cellular phone, a personal digital assistant (PDA), a smart phone, and a multimedia device, or a non-portable device such as a personal computer (PC) and a vehicle-mounted device.

Although Unstructured Data Storage network Function (UDSF), Structured Data Storage network Function (SDSF), Network Exposure Function (NEF), and NF Repository Function (NRF) are not shown in FIG. 1 for clarity of explanation, all the NFs shown in FIG. 1 can perform interaction with the UDSF, the NEF and the NRF, if necessary.

The SDSF is structured data by any NEF and is a selective function to support a storage and retrieval function of information.

The UDSF is unstructured data by any NF and is a selective function to support a storage and retrieval function of information.

The following illustrates the service-based interfaces included in the 5G system architecture as represented in FIG. 1.

Namf: Service-based interface exhibited by the AMF

Nsmf: Service-based interface exhibited by the SMF

Nnef: Service-based interface exhibited by the NEF

Npcf: Service-based interface exhibited by the PCF

Nudm: Service-based interface exhibited by the UDM

Naf: Service-based interface exhibited by the AF

Nnrf: Service-based interface exhibited by the NRF

Nausf: Service-based interface exhibited by the AUSF

The NF service is one type of capability exposed by an NF (i.e., NF service producer) to other NF (i.e., NF service consumer) via the service-based interface. The NF can expose one or more NF service(s). The following standard is applied to define the NF service.

The NF services are derived from information flow for explaining an end-to-end function.

Complete end-to-end message flow is explained by a sequence of NF service invocation.

Two operations that the NF(s) provide its services via the service-based interface are as follows:

i) “Request-response”: A control plane NF_B (i.e., NF service producer) is requested from another control plane NF_A (i.e., NF service consumer) to provide a certain NF service (including performing an operation and/or providing information). The NF_B responses NF service result based on information provided by the NF_A in the Request.

In order to fulfil the request, the NF_B may in turn consume NF services from other NF(s). In Request-response mechanism, communication is performed one to one between two NFs (i.e., consumer and producer).

ii) “Subscribe-Notify”

A control plane NF_A (i.e., NF service consumer) subscribes to a NF service provided by another control plane NF_B (i.e., NF service producer). Multiple control plane NFs may subscribe to the same control plane NF service. The NF_B notifies a result of this NF service to the interested NFs that are subscribed to this NF service. A subscription request from the consumer may include a notification request for periodic update or notification triggered through specific events (e.g., change of requested information, reaching a certain critical value, etc.). This mechanism also includes the case where the NF(s) (e.g., NF_B) implicitly subscribes to a specific notice without an explicit subscription request (e.g., the case where the NF(s) subscribes through a successful registration procedure).

FIG. 2 illustrates a wireless communication system architecture to which the present invention may be applied.

In the 3GPP system, a conceptual link connecting NFs in a 5G system is defined as a reference point. Next, the reference point included in the 5G system architecture represented as in FIG. 2 is illustrated.

N1 (or NG1): Reference point between UE and AMF

N2 (or NG2): Reference point between (R)AN and AMF

N3 (or NG3): Reference point between (R)AN and UPF

N4 (or NG4): Reference point between SMF and UPF

N5 (or NG5): Reference point between PCF and AF

N6 (or NG6): Reference point between UPF and data network

N24 (or NG24): Reference point between PCF in visited network and PCF in home network

(or NG8): Reference point between UDM and AMF

N9 (or NG9): Reference point between two core UPFs

N10 (or NG10): Reference point between UDM and SMF

N11 (or NG11): Reference point between AMF and SMF

N12 (or NG12): Reference point between AMF and AUSF

N13(or NG13): Reference point between UDM and authentication server function (AUSF)

N14 (or NG14): Reference point between two AMFs

N15 (or NG15): Reference point between PCF and AMF in case of non-roaming scenario and reference point between PCF and AMF in visited network in case of roaming scenario

N16 (or NG16): Reference point (reference point between SMF in visited network and SMF in home network in case of roaming scenario) between two SMFs

N17 (or NG17): Reference point between AMF and EIR

N18 (or NG18): Reference point between any NF and UDSF

N19 (or NG19): Reference point between NEF and SDSF

Meanwhile, in FIG. 2, for convenience of description, a reference model for a case where the UE accesses one DN using one PDU session is illustrated, but the present disclosure is not limited thereto.

FIG. 3 illustrates a wireless communication system architecture to which the present invention may be applied.

In FIG. 3, a non-roaming 5G system architecture for a UE which concurrently accesses two (i.e., local and central) data networks (DNs) by using multiple PDU sessions is illustrated using the reference point representation.

In FIG. 3, an architecture for multiple PDU sessions is illustrated with respect to a case where two SMFs are selected for different PDU sessions. However, each SMF may have a capability to control both local UPF and central UPF in the PDU session.

FIG. 4 illustrates a wireless communication system architecture to which the present invention may be applied.

In FIG. 4, a non-roaming 5G system architecture for a case where a concurrent access to two (i.e., local and central) data networks (DNs) is provided in a single PDU session is illustrated using the reference point representation.

FIG. 5 illustrates a wireless communication system architecture to which the present invention may be applied.

In FIG. 5, a roaming 5G system architecture in the case of an LBO scenario having a service-based interface in a control plane is illustrated.

FIG. 6 illustrates a wireless communication system architecture to which the present invention may be applied.

In FIG. 6, a roaming 5G system architecture in the case of a home routed scenario having the service-based interface in the control plane is illustrated.

FIG. 7 illustrates a wireless communication system architecture to which the present invention may be applied.

In FIG. 7, a roaming 5G system architecture in the case of the LBO scenario is illustrated using the reference point representation.

FIG. 8 illustrates a wireless communication system architecture to which the present invention may be applied.

In FIG. 8, a roaming 5G system architecture in the case of the home routed scenario is illustrated using the reference point representation.

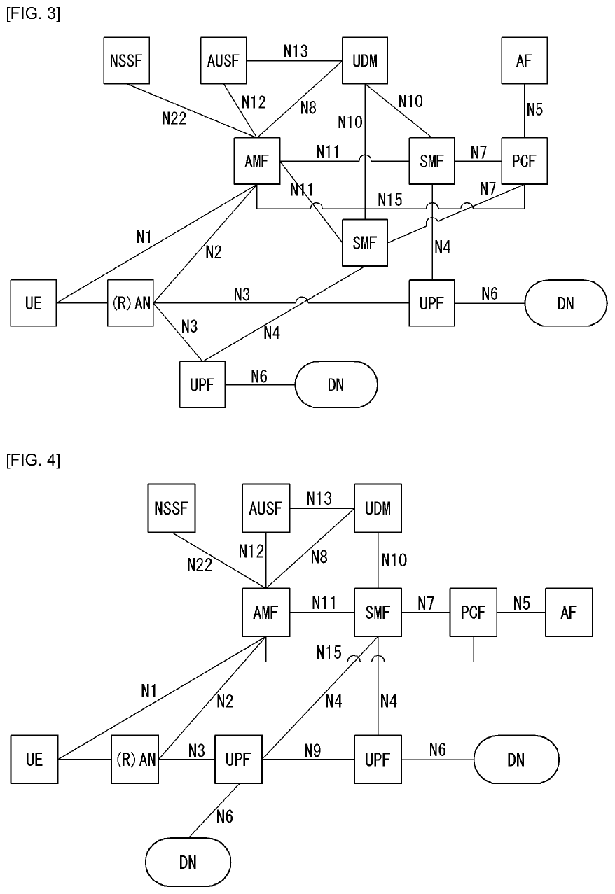

FIG. 9 illustrates an NG-RAN architecture to which the present invention may be applied.

Referring to FIG. 9, a next generation radio access network (NG-RAN) is constituted by gNB (NR NodeB)(s) and/or eNB (eNodeB)(s) providing user plane and control plane protocols toward the UE.

gNB(s) and gNB and eNB(s) connected to 5GC are connected to each other by using an Xn interface. The gNB(s) and the eNB(s) are also connected to the 5GC by using an NG interface and more specifically, the gNB(s) and the eNB(s) are connected to the AMF by using an NG-C interface (i.e., N2 reference point) which is a control plane interface between the NG-RAN and the 5GC and connected to the UPF by using an NG-U interface (i.e., N3 reference point) which is a user plane interface between the NG-RAN and the 5GC.

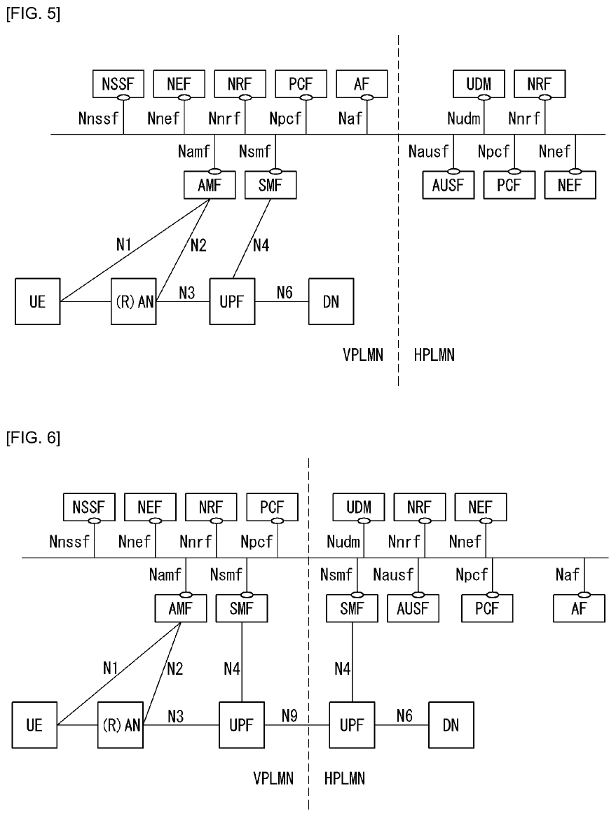

FIG. 10 is a diagram illustrating a radio protocol stack in a wireless communication system to which the present invention may be applied.

FIG. 10A illustrates a radio interface user plane protocol stack between the UE and the gNB and FIG. 10B illustrates a radio interface control plane protocol between the UE and the gNB.

The control plane means a passage through which control messages which the UE and the network use for managing a call are sent. The user plane means a passage through which data generated in an application layer, e.g., voice data or Internet packet data is sent.

Referring to FIG. 10A, the user plane protocol stack may be divided into a first layer (Layer 1) (i.e., a physical layer (PHY)) and a second layer (Layer 2).

Referring to FIG. 10B, the control plane protocol stack may be divided into the first layer (i.e., the PHY layer), the second layer, a third layer (i.e., a radio resource control (RRC) layer), and a Non-Access Stratum (NAS) layer.

The Layer 2 is divided into a Medium Access Control (MAC) sublayer, a Radio Link Control (RLC) sublayer, a Packet Data Convergence Protocol (PDC) sublayer, and a Service Data Adaptation Protocol (SDAP) sublayer (in case of the user plane).

A radio bearer is classified into two groups: data radio bearer (DRB) for user plane data and signaling radio bearer (SRB) for control plane data.

Each layer of the control plane and the user plane of the radio protocol is described below.

1) The Layer 1, i.e., the PHY layer, provides information transfer service to an upper layer by using a physical channel. The PHY layer is connected to the MAC sublayer located at an upper level through a transport channel, and data are transmitted between the MAC sublayer and the PHY layer through the transport channel. The transport channel is classified according to how and which feature data is transmitted via a radio interface. And, data is transmitted between different PHY layers, between a PHY layer of a transmitter and a PHY layer of a receiver, through a physical channel.

2) The MAC sublayer performs mapping between a logical channel and a transport channel; multiplexing/demultiplexing of MAC Service Data Unit (SDU) belonging to one or different logical channel(s) to/from a transport block (TB) delivered to/from the PHY layer through a transport channel; scheduling information reporting; error correction through hybrid automatic repeat request (HARQ); priority handling between UEs using dynamic scheduling; priority handling between logical channels of one UE using logical channel priority; and padding.

Different kinds of data deliver a service provided by the MAC sublayer. Each logical channel type defines what type of information is delivered.

The logical channel is classified into two groups: a Control Channel and a Traffic Channel.

i) The Control Channel is used to deliver only control plane information and is as follows.

Broadcast Control Channel (BCCH): a downlink channel for broadcasting system control information.

Paging Control Channel (PCCH): a downlink channel that delivers paging information and system information change notification.

Common Control Channel (CCCH): a channel for transmitting control information between a UE and a network. This channel is used for UEs having no RRC connection with the network.

Dedicated Control Channel (DCCH): a point-to-point bi-directional channel for transmitting dedicated control information between the UE and the network. This channel is used by the UE having an RRC connection.

ii) The Traffic Channel is used to use only user plane information.

Dedicated Traffic Channel (DTCH): a point-to-point channel, dedicated to a single UE, for delivering user information. The DTCH may exist in both uplink and downlink.

In the downlink, connection between the logical channel and the transport channel is as follows.

The BCCH may be mapped to BCH. The BCCH may be mapped to DL-SCH. The PCCH may be mapped to PCH. The CCCH may be mapped to the DL-SCH. The DCCH may be mapped to the DL-SCH. The DTCH may be mapped to the DL-SCH.

In the uplink, connection between the logical channel and the transport channel is as follows. The CCCH may be mapped to UL-SCH. The DCCH may be mapped to the UL-SCH. The DTCH may be mapped to the UL-SCH.

3) The RLC sublayer supports three transmission modes: a Transparent Mode (TM), an Unacknowledged Mode (UM), and an Acknowledged Mode (AM).

The RLC configuration may be applied for each logical channel. In case of SRB, the TM or the AM is used. On the other hand, in case of DRB, the UM the AM is used.

The RLC sublayer performs the delivery of the upper layer PDU; sequence numbering independent of PDCP; error correction through automatic repeat request (ARQ); segmentation and re-segmentation; reassembly of SDU; RLC SDU discard; and RLC re-establishment.

4) A PDCP sublayer for the user plane performs Sequence Numbering; header compression and decompression (Robust Header Compression (RoHC) only); delivery of user data; reordering and duplicate detection (if the delivery to a layer above the PDCP is required); PDCP PDU routing (in case of a split bearer); re-transmission of PDCP SDU; ciphering and deciphering; PDCP SDU discard; PDCP re-establishment and data recovery for RLC AM; and duplication of PDCP PDU.

The PDCP sublayer for the control plane additionally performs Sequence Numbering; ciphering, deciphering and integrity protection; delivery of control plane data; duplicate detection; and duplication of PDCP PDU.

When duplication is configured for a radio bearer by RRC, an additional RLC entity and an additional logical channel are added to the radio bearer to control the duplicated PDCP PDU(s). The duplication at PDCP includes transmitting the same PDCP PDUs twice. Once it is transmitted to the original RLC entity, and a second time it is transmitted to the additional RLC entity. In this instance, the original PDCP PDU and the corresponding duplicate are not transmitted to the same transport block. Two different logical channels may belong to the same MAC entity (in case of CA) or different MAC entities (in case of DC). In the former case, logical channel mapping restriction is used to ensure that the original PDCP PDU and the corresponding duplicate are not transmitted to the same transport block.

5) The SDAP sublayer performs i) mapping between QoS flow and data radio bearer, and ii) QoS flow identification (ID) marking in downlink and uplink packet.

A single protocol entity of SDAP is configured for each individual PDU session, but exceptionally, in case of dual Connectivity (DC), two SDAP entities can be configured.

6) A RRC sublayer performs broadcast of system information related to Access Stratum (AS) and Non-Access Stratum (NAS); paging initiated by 5GC or NG-RAN; establishment, maintenance and release of RRC connection between UE and NG-RAN (additionally including modification and release of carrier aggregation and also additionally including modification and release of Dual Connectivity between E-UTRAN and NR or in NR); security function including key management; establishment, configuration, maintenance and release of SRB(s) and DRB(s); delivery of handover and context; UE cell selection and re-release and control of cell selection/reselection: mobility function including inter-RAT mobility; QoS management function, UE measurement reporting and control of reporting; detection of radio link failure and recovery from radio link failure; and NAS message delivery from NAS to UE and NAS message delivery from UE to NAS.

Session and Service Continuity (SSC)

In 3GPP SA2, discussion about a method for supporting session and service continuity according to the mobility of a UE is in progress.

In a next-generation system (e.g., 5G system), a solution for supporting three SSC modes is discussed.

In the solution, a PDU session present between a UE and a user plane function (hereinafter referred to as a “terminating user-plane function (TUPF)”, but may be substituted with the above-described UPF) is assumed. The TUPF terminates a 3GPP user plane, and interacts with a data network.

1) SSC Mode Definition

A next-generation system supports the following SSC modes.

SSC mode 1: the same TUPF is maintained regardless of an access technology (e.g., RAT and cell) being used by a UE in order to access a network.

SSC mode 2: the same TUPF is maintained only through a partial set (i.e., one or more, but not all) of access network attachment points (e.g., cell and RAT) referred to as the serving area of a TUPF. When a UE gets out of the serving area of a TUPF, the UE is served by a different TUPF suitable for a new attachment point to the network of the UE.

SSC mode 3: in this mode, a network allows the establishment of UE continuity toward the same data network (DN) via a new TUPF before a connection between the UE and a previous TUPF is terminated. When a trigger condition is applied, the network selects a target TUPF suitable for a new attachment point toward the network of the UE. While the two TUPFs are activated, the UE actively rebinds an application from a previous address/prefix to a new address/prefix or waits until a flow bound with a previous address/prefix is terminated.

2) Mode Selection and Network Support

In relation to mode selection and network support, the following principle is applied:

When requesting a PDU session, a UE may indicate a requested SSC mode as part of PDU session setup signaling with respect to a network. A method of determining a requested SSC mode by a UE is described later.

A serving network receives, from a subscription database, a list of SSC modes supported for each data network for each subscriber and a default SSC mode as part of subscription information.

The serving network selects an SSC mode by accepting the requested SSC mode or modifying the requested SSC mode based on the subscription information and/or a local configuration.

When the UE requests a new PDU session, if an SSC mode is not provided, the network applies the local configuration for selecting a default SSC mode (for connection to a data network) listed in the subscription information or selecting the SSC mode.

After selecting the SSC mode, (a) the network accepts the PDU session request from the UE and indicates the selected SSC mode accepted for the UE or (b) the network rejects the PDU session request and transmits the selected SSC mode and a cause value to the UE in order to indicate that the selected SSC mode is already used by another PDU session within the UE.

The SSC mode is applied for each PDU session. The UE requests a different SSC mode in a different PDU session. That is, different PDU sessions activated at the same time for the same UE may have different SSC modes.

The SSC mode is not changed during the lifetime of the PDU session.

TUPF selection: when selecting a TUPF for the PDU session, the network takes into considerate on the current attachment point of the UE and the requested SSC mode.

3) SSC Mode 1

In relation to the SSC mode 1, the following principle is applied:

An allocated TUPF is maintained during the lifetime of a PDU session. That is, the TUPF is not changed by a network.

4) SSC Mode 2

In relation to the SSC mode 2, the following principle is applied:

Redirection trigger to a different TUPF: a network determines whether a TUPF allocated to the PDU session of a UE needs to be redirected based on UE mobility, a local policy (i.e., information on the serving area of the allocated TUPF).

Redirection procedure: a network redirects traffic of a UE to a different TUPF by first releasing a user plane path associated with a current TUPF and then setting up a user plane path corresponding to a new TUPF. The following two solutions are used. In one solution, when a TUPF is reallocated, a PDU session is preserved. In the other solution, a network disconnects the PDU session of a UE corresponding to a current TUPF and requests the UE to immediately activate a PDU session (a result of the selection of a new TUPF) again. During the process, the UE maintains an attached state. The network selects a TUPF based on the current attachment point of the UE toward the network.

5) SSC Mode 3

In relation to the SSC mode 3, the following principle is applied:

Redirection trigger toward a different TUPF: a network determines whether a TUPF allocated to the PDU session of a UE needs to be redirected based on a local policy (i.e., information on the serving area of the allocated TUPF).

Redirection procedure: a network indicates whether traffic on one of the activated PDU sessions of a UE needs to be redirected with respect to the UE. Furthermore, the network starts a timer and indicates a timer value with respect to the UE. A user plane path is established toward a new TUPF. The following two solutions are used. In one solution, a PDU session is reused for an additional user plane path. In the other solution, an additional PDU session is re-established. The network selects a TUPF based on the current attachment point of the UE toward the network. If a UE has transmitted a request for an additional PDU session to the same DN without previous indication, indicating that an activated PDU session needs to be redirected, from a network, the network rejects the request of the UE.

If a new user plane path associated with the new TUPF has been established, the UE may perform one of the following options.

Option 1: the UE actively redirects an application flow, bound with a previous TUPF, to a new TUPF (e.g., using a higher layer session continuity mechanism). When the UE completes the redirection of the application flow to the new TUPF, the previous TUPF is released.

Option 2: the UE steers a new application flow toward a new TUPF. A previous flow via a previous TUPF continues until the flow is terminated. When all flows using the previous TUPF are terminated, the previous TUPF is released. When Option 2 is used, a multi-homed PDU session may be used to transmit an application flow bound with the previous TUPF. A tunnel between the previous TUPF and the new TUPF is used to forward such a flow.

If a previous TUPF has not been released when a timer expires or a network detects that a previous TUPF has been deactivated, the network releases the previous TUPF.

Hereinafter, terms used in this specification will be described below.

5GMM-IDLE mode: The UE in the 5GMM-IDLE mode means 5GMM-IDLE mode over 3GPP access or a 5GMM-IDLE mode over non-3GPP access.

5GMM-CONNECTED mode: The UE in 5GMM-CONNECTED mode means a 5GMM-CONNECTED mode through the 3GPP access or a 5GMM-CONNECTED mode over the non-3GPP access.

5GMM-IDLE mode over 3GPP access: UE is in 5GMM-IDLE mode over the 3GPP access when there is no N1 NAS signaling connection over the 3GPP access between the UE and the network. This corresponds to the CM-IDLE state for the 3GPP access.

5GMM-CONNECTED mode over 3GPP access: The UE is in the 5GMM-IDLE mode over the 3GPP access when there is the N1 NAS signaling connection over the 3GPP access between the UE and the network. This term corresponds to the CM-CONNECTED state for the 3GPP access.

5GMM-IDLE mode over non-3GPP access: The UE is in the 5GMM-IDLE mode over the non-3GPP access when there is no N1 NAS signaling connection over the non-3GPP access between the UE and the network. This corresponds to the CM-IDLE state for the non-3GPP access.

5GMM-CONNECTED mode over non-3GPP access: The UE is in the 5GMM-CONNECTED mode over the non-3GPP access when there is the N1 NAS signaling connection over the 3GPP access between the UE and the network. This term corresponds to the CM-CONNECTED state for the non-3GPP access.

N1 mode: A mode of the UE that is allowed to access a 5G core network via a 5G access network.

N1 NAS signaling connection: Peer-to-peer S1 mode connection between the UE and the AMF. The N1 NAS signaling connection means concatenation of NG connection via an N2 reference point for the 3GPP access and RRC connection via a Uu reference point or concatenation of NG connection via the N2 reference point for the non-3GPP access and an Internet protocol security (IPsec) tunnel via an NWu reference point.

Mobile Originated (MO) Short Message Service (SMS) Using One Step Approach in Connection Management (CM)-IDLE

1) MO SMS Procedure Over NAS in CM-IDLE

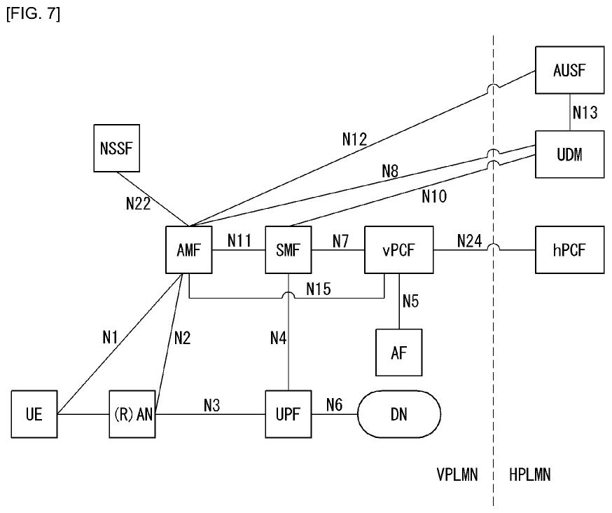

FIG. 11 illustrates an MO SMS procedure over NAS in a wireless communication system to which the present invention may be applied.

1. When the UE under CM_IDLE mode is going to send uplink SMS message, then the UE and the network perform the UE triggered Service Request procedure firstly in order to establish a NAS signaling connection to the AMF.

2. The UE builds the SMS message to be sent. The SMS message is encapsulated in an NAS message with an indication indicating that the NAS message is for SMS transporting. The UE sends the NAS message to the AMF. The AMF forwards the SMS message and a Subscription Permanent Identifier (SPUI) to the SMSF serving the UE over N17 using an uplink unit data message to permit the SMSF to create an accurate charging record. Further, the AMF adds the International Mobile station Equipment Identity and Software Version number (IMEISV), the local time zone, and the UE's current Tracking Area Identity (TAI) and E-UTRAN Cell Global Identifier (eCGI) or CGI for NR (x-CGI). The AMF forwards the SMS ack message from the SMSF to the UE using a downlink unit data message.

3-5. This step is based on the existing procedure defined in 3GPP TS 23.040.

6. The SMSF forwards the delivery report to the AMF via a downlink unit data message which is forwarded to the UE via Downlink NAS transport.

7. When no more SMS data is to be forwarded to UE, the SMSF requests the AMF to terminate this SMS transaction.

2) MO SMS Using One Step Approach in CM-IDLE

The UE may request during a registration procedure to be able to perform NAS transport in the initial NAS message. The AMF determines whether to accept or reject based on its capability and local configuration.

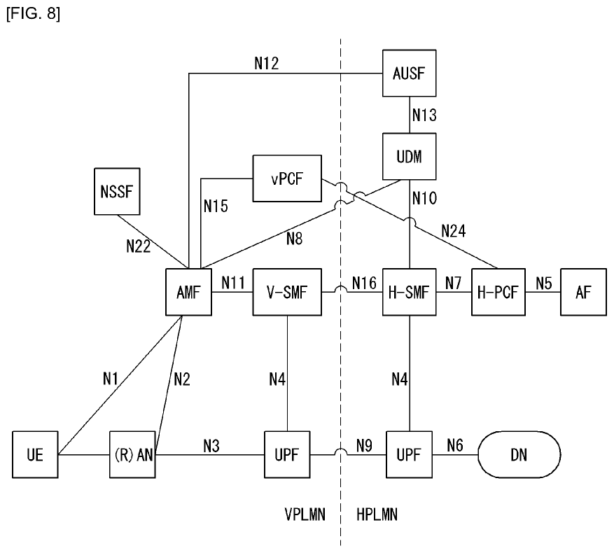

FIG. 12 illustrates an MO SMS procedure using the one step approach in CM-IDLE in a wireless communication system to which the present invention may be applied.

FIG. 12 illustrates a procedures for UE originated SMS messages using NAS Transport when the UE is in the CM-IDLE mode with the one step approach.

1. After successful negotiation, when the UE is in the CM-IDLE mode, and the UE needs to transport the SMS over the NAS, the UE may send the Payload Type and SMS Payload in the initial NAS message.

2. The AMF sends a response to the initial NAS message whether to accept or reject the UE initial NAS message.

Step 3-7 follows clause 4.3.3.2 of TS 23.502 V15.0.0.

3) MO SMS Procedure Over NAS in CM-CONNECTED

In the MO SMS procedure in the CM-CONNECTED mode, the MO SMS in the CM-IDLE mode is reused without a UE triggered service request procedure.

NAS Transport

1) Motivation for NAS Transport

NAS transport between UE and AMF for SM Signaling

With the introduction of control plane functionality being split between the AMF and SMF in the 5G system, routing of NAS messages in the 5G Core Network has been discussed.

The conclusion up to now is as follows.

NAS signaling is terminated in the AMF.

The UE sends SM signaling over a “transport” to the AMF, indicating 1) that SM Signaling is being transported and 2) sufficient information (referred to as routing information) to the AMF to further forward the SM signaling to the appropriate SMF.

In case of a NAS procedure regarding a new PDU session, this includes selecting the appropriate SMF.

In case of a NAS procedure regarding an existing PDU session, this includes selecting the SMF already serving the PDU session.

The AMF may also determine whether the UE is allowed to communicate to the SMF and provides the NAS security.

Note that apart from the required information to route the SM Signaling to the right SMF, the AMF does not process the actual SM message.

The same notion is applied for downlink SM signaling.

This allows a full modularization between the 5G NAS protocol between UE and AMF, and the SM protocol between UE and SMF, which brings the following advantages.

Forward compatibility, e.g. a Rel-15 AMF may still be able to carry SM payload for a Rel-16+SM (in the UE) and Re116+ SMF.

The handling of multiple SM instances in the UE and AMF is simplified.

Accordingly, SM Signaling is transported between UE and AMF as payload. A NAS message transporting SM signaling as payload and contains the following information.

Information added and processed at UE and AMF

The Type of Payload (e.g., SM Signaling)

Routing Information

Payload: SM Signaling message

This is only processed by the UE SM layer and the SMF (i.e., it is transparent to the AMF).

Generalization of NAS transport for other services (SMS, etc., potentially other types of payload)

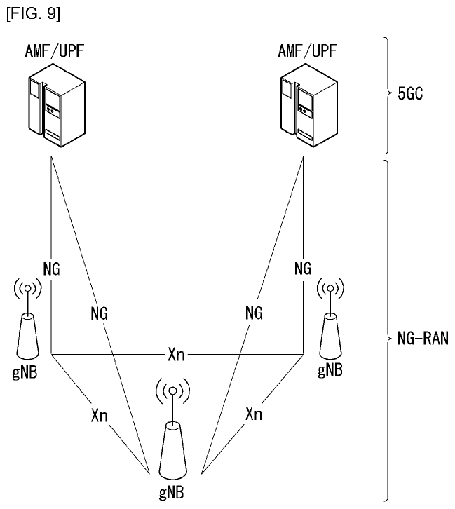

FIG. 13 illustrates NAS transport including SM and other services in a wireless communication system to which the present invention may be applied.

There are other examples of payload being transported over NAS via the AMF.

For example, it was agreed to support SMS over 5G NAS. There may also be other messages that need to be transported over NAS between UE and AMF in the future (e.g., location services).

In all these examples, there is a common behaviour in the UE and AMF regarding the transport of the message.

NAS security (integrity protection, ciphering) is provided for the transport of the payload (e.g., SMS message or SM signaling).

Type of payload: SM Signaling, SMS.

Routing of the transported payload to the right entity:

In the case of SM signaling, routing to the right SMF in the network and routing to the right SM instance in the UE.

In the case of SMS, this field may not be needed.

There are existing examples of payload transported between UE and MME in EPS:

NAS transport procedure: defined for SMS.

Generic NAS transport procedure: defined for location services over NAS.

Control Plane Service Request and ESM data transport: defined for data transport over NAS.

These procedures were defined in different releases and defined separately. However, in 5G, there is no reason to partition the transport of different types of payload into different procedures.

Accordingly, it is proposed to define common 5G NAS transport procedure between the UE and AMF capable of transporting different types of payload, (e.g., SMS, SM signaling), between the UE and AMF. A NAS message transporting SM signaling as payload and contains the following information:

Information added and processed at UE and AMF

The Type of Payload (e.g., SM Signaling, SMS, etc.)

(Conditional) Routing Information

Payload (The SM Signaling message

This payload is transparent to the AMF.

2) NAS Transport Over Existing NAS Connection

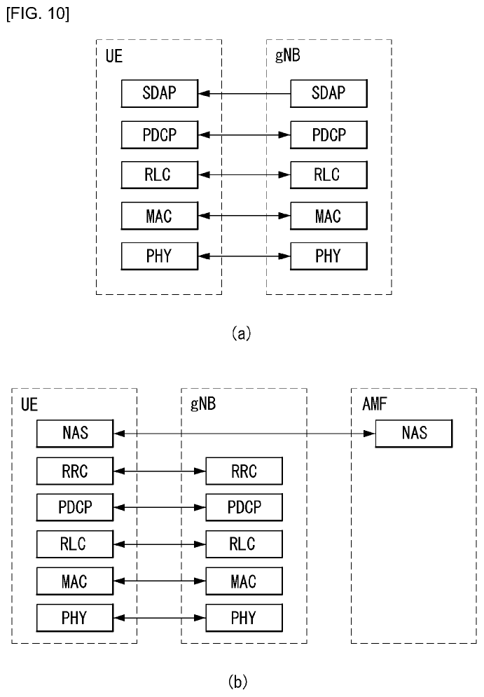

FIG. 14 illustrates NAS transport for SM signaling in a wireless communication system to which the present invention may be applied.

When the UE is in a CM-CONNECTED mode, and the UE (or AMF) need to transport a payload (e.g., SM signaling or SMS) over NAS, the UE (or AMF) inserts the payload in the payload information element (IE) of a NAS Transport message.

Depending on the payload type, the UE (or AMF) populates the payload type and the routing information.

3) NAS Transport from Idle Mode

There are two approach methods for NAS transport when the UE is in idle mode:

Option 1: The UE performs:

1. First, a regular service request to establish a secure NAS connection.

2. After NAS connection is established, initiate regular NAS transport in connected mode.

Option 2: The payload type information, routing information and the actual Payload (e.g., the SM message, SMS) is transmitted in an initial NAS message.

This is a similar approach from the control plane service request, and would require the possibility of transmitting ciphered payload apart from the integrity protection.

Option 1 may be used in the case where the network only accepts a “lean” service request message to move from CM-IDLE to CM-CONNECTED mode. This size is not sufficient for the size required to transmit payload type, routing information and the actual payload.

Option 2 has the benefit that SM messages and SMS may be sent without the need for a round trip delay caused by an initial service request procedure.

It is proposed that both options are allowed by standards.

The UE and the network need to negotiate the use of Option 2 during registration procedure. That is, the UE needs to request and the network accept that the UE can send the payload type, routing information and payload in an initial NAS message.

4) Agreement on NAS Transport

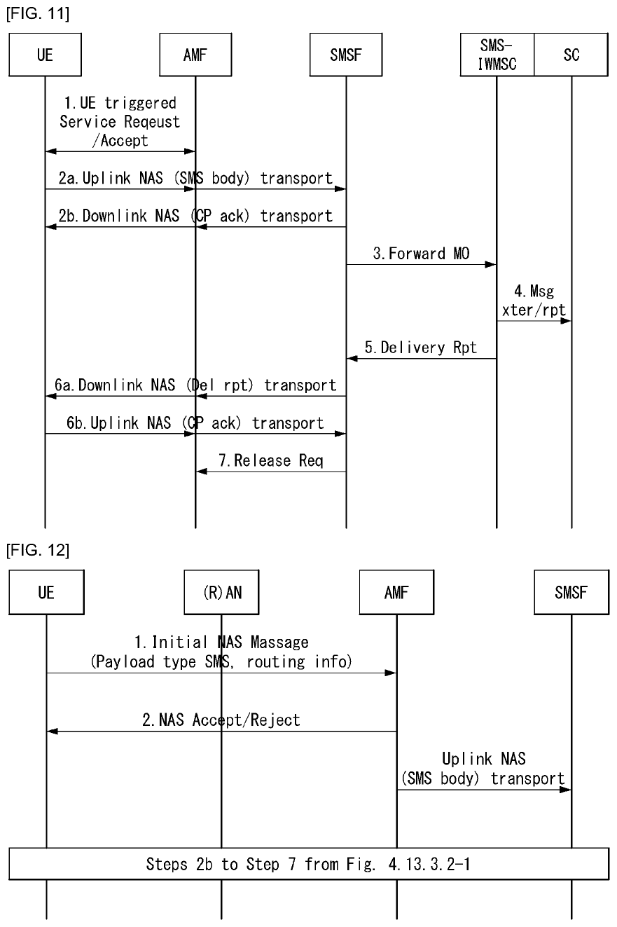

FIG. 15 illustrates NAS transport for SM, SMS, and other services in a wireless communication system to which the present invention may be applied.

NAS transport is used to transport and route different types of payload between the UE and the AMF.

The payload types carried over NAS transport include: SM Signaling, SMS.

NAS transport provides the following functionality: NAS security (integrity protection, ciphering) for the transport of the payload and Routing of the transported payload to the right network function

The NAS transport message contains: Payload type, Payload Routing Information (e.g., information to enable the AMF to select a new SMF or address an existing SMF, in case of SM signaling), and Payload (e.g., the SM message in case of SM signaling)

Security of the NAS messages is provided based on the security context established by the UE with the AMF and authenticated by the AMF.

When the UE is in a CM-CONNECTED mode, and the UE (or AMF) need to transport a payload (e.g., SM signaling or PCF) over NAS, the UE (or AMF) inserts the payload into the payload information element (IE) of a NAS Transport message. Depending on the payload type, the UE (or AMF) populates the payload type and the routing information.

When the UE is in a CM-IDLE mode and requires transporting a payload over NAS, the UE may initiate the service request procedure to transition to the CM-CONNECTED mode. After successful completion of service request, the UE sends the NAS Transport message as described for the CM-CONNECTED mode case.

Alternatively, the UE may request during registration procedure to be able to perform NAS transport in an initial NAS message. The AMF determines whether to accept or reject based on support and local configuration. After successful negotiation, when the UE is in the CM-IDLE mode and the UE needs to transport a payload over NAS, the UE can send the payload type, the routing information, and the payload in an initial NAS message.

NAS Transport Procedure

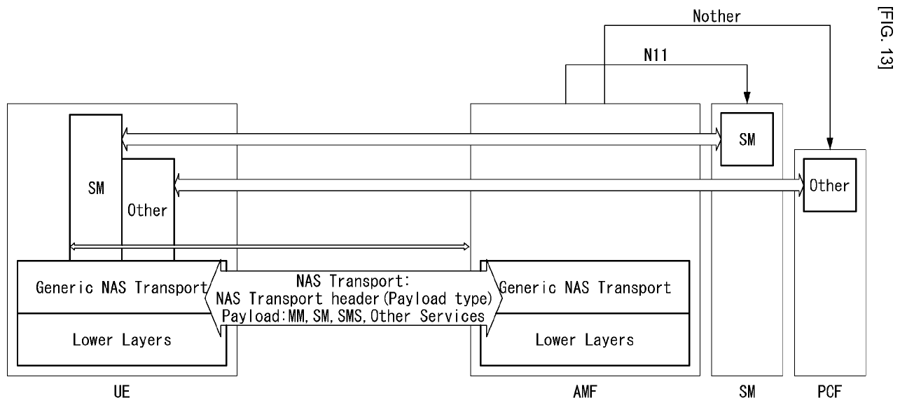

FIG. 16 illustrates an NAS transport procedure originated by the UE when the UE is in the CM-CONNECTED mode in a wireless communication system to which the present invention may be applied.

When the UE needs to transport a payload over NAS, the UE creates a NAS transport message indicating a payload type (e.g., SMS, SM signaling), routing information (if needed), and an actual payload. The AMF determines whether the UE is allowed to transmit this payload type to a target network function (NF) according to the routing information.

If the AMF determines that the UE is not allowed to transmit the payload, or any other errors are detected, the AMF may not forward the payload and may send a NAS reject message to the UE with an appropriate cause code.

If the AMF determines that the UE is allowed to transmit the payload, the AMF uses the routing information in the message to route the message to the intended NF.

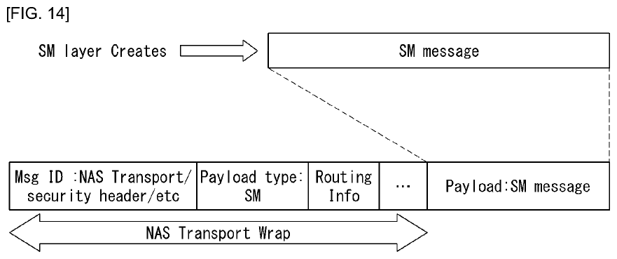

FIG. 17 illustrates a two-step NAS transport procedure originated by the UE when the UE is in the CM-IDLE mode in a wireless communication system to which the present invention may be applied.

UE and AMF execute UE triggered service request procedures.

If the UE transitions to CM_CONNECTED mode, then NAS messages are sent using the procedure according to FIG. 16 above.

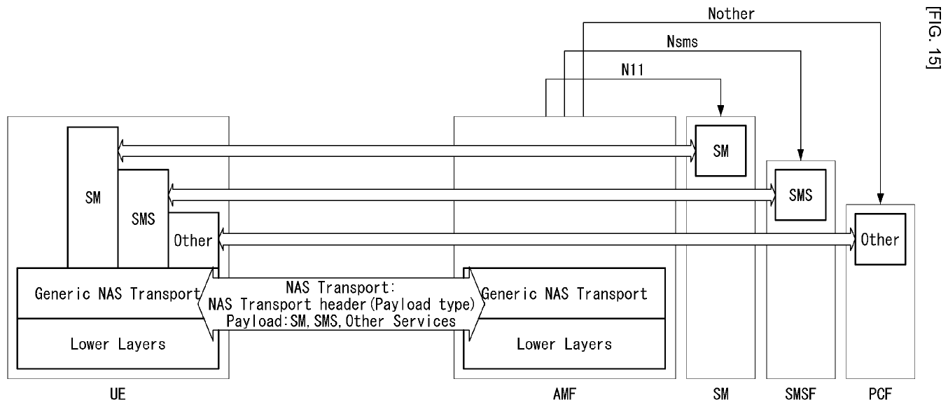

FIG. 18 illustrates a one-step NAS transport procedure originated by the UE when the UE is in the CM-IDLE mode in a wireless communication system to which the present invention may be applied.

The UE may request during registration procedure to be able to perform NAS transport in an initial NAS message. The AMF determines whether to accept or reject based on support and local configuration.

After successful negotiation, when the UE is in the CM-IDLE mode and the UE needs to transport a payload over NAS, the UE may send the payload type, the routing information, and the payload in an initial NAS message. The AMF determines whether the UE is allowed to transmit this payload type to the target NF according to the routing information.

The AMF sends a response to the initial NAS message either accepting or rejecting the UE initial NAS message.

If the AMF determines that the UE is allowed to transmit that Payload and establish a NAS connection, the AMF uses the routing information in the message to route the message to the intended NF.

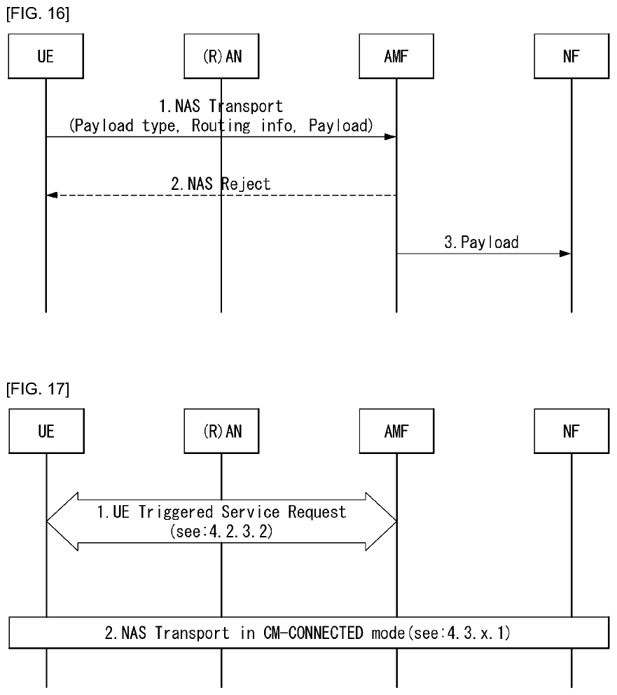

FIG. 19 illustrates an NAS transport procedure originated by the network when the UE is in the CM-CONNECTED mode in a wireless communication system to which the present invention may be applied.

The NF message is sent to the AMF over the appropriate interface.

The AMF inserts with NF message into NAS transport payload, encrypts and NAS transport message including the payload, adds integrity check and sends it to the UE.

On receive the NAS transport message, the UE decrypts NAS transport payload and uses the routing information to forward the payload to the corresponding NF module in the UE.

UE Requested PDN Connectivity Procedure not Accepted by Network

If connectivity with the requested PDN cannot be accepted by the network, the MME shall send a PDN CONNECTIVITY REJECT message to the UE. The message shall contain a procedure transaction identity (PTI) and an ESM cause value indicating the reason for rejecting the UE requested PDN connectivity.

The ESM cause IE indicates one of the following ESM cause values:

#8: operator determined barring;

#26: insufficient resources;

#27: missing or unknown APN;

#28: unknown PDN type;

#29: user authentication failed;

#30: request rejected by Serving GW or PDN GW;

#31: request rejected, unspecified;

#32: service option not supported;

#33: requested service option not subscribed;

#34: service option temporarily out of order;

#35: PTI already in use;

#38: network failure;

#50: PDN type IPv4 only allowed;

#51: PDN type IPv6 only allowed;

#53: ESM information not received;

#54: PDN connection does not exist;

#55: multiple PDN connections for a given APN not allowed;

#57: PDN type IPv4v6 only allowed;

#58: PDN type non IP only allowed;

#65: maximum number of EPS bearers reached;

#66: requested APN not supported in current RAT and PLMN combination;

#95-111: protocol errors;

#112: APN restriction value incompatible with active EPS bearer context;

#113: Multiple accesses to a PDN connection not allowed.

The network may include a Back-off timer value IE in the PDN CONNECTIVITY REJECT message. If the ESM cause value is #26 “insufficient resources” and the PDN CONNECTIVITY REQUEST message was received via a NAS signaling connection established with RRC establishment cause “High priority access AC 11-15” or the request type in the PDN CONNECTIVITY REQUEST message was set to “emergency” or “handover of emergency bearer services”, the network shall not include a Back-off timer value IE.

If the Back-off timer value IE is included and the ESM cause value is different from #26 “insufficient resources”, #50 “PDN type IPv4 only allowed”, #51 “PDN type IPv6 only allowed”, #57 “PDN type IPv4v6 only allowed”, #58 “PDN type non IP only allowed” and #65 “maximum number of EPS bearers reached”, the network may include the Re-attempt indicator IE to indicate whether the UE is allowed to attempt a PDP context activation procedure in the PLMN for the same APN in A/Gb or Iu mode, and whether another attempt in A/Gb and Iu mode or in S1 mode is allowed in an equivalent PLMN.

If the ESM cause value is #50 “PDN type IPv4 only allowed”, #51 “PDN type IPv6 only allowed”, #57 “PDN type IPv4v6 only allowed” or #58 “PDN type non IP only allowed”, the network may include the Re-attempt indicator IE without Back-off timer value IE to indicate whether the UE is allowed to attempt a PDN connectivity procedure in an equivalent PLMN for the same APN in S1 mode using the same PDN type.

If the ESM cause value is #66 “requested APN not supported in current RAT and PLMN combination”, the network may include the Re-attempt indicator IE without Back-off timer value IE to indicate whether the UE is allowed to attempt a PDN connectivity procedure in an equivalent PLMN for the same APN in S1 mode.

Upon receipt of the PDN CONNECTIVITY REJECT message, the UE shall stop timer T3482 and enter the state PROCEDURE TRANSACTION INACTIVE.

If the PDN CONNECTIVITY REJECT message is due to an ESM failure notified by EMM layer (i.e., EMM cause #19 “ESM failure” included in an ATTACH REJECT message), the UE may include a different APN in the PDN CONNECTIVITY REQUEST message.

If the PDN CONNECTIVITY REQUEST message was sent with request type set to “emergency” or “handover of emergency bearer services” in a stand-alone PDN connectivity procedure and the UE receives a PDN CONNECTIVITY REJECT message, then the UE may inform the upper layers of the failure to establish the emergency bearer.

5GMM-IDLE Mode

N1 mode: A mode of the UE that is allowed to access a 5G core network via a 5G access network.

N1 NAS signaling connection: Peer-to-peer S1 mode connection between the UE and the AMF. The N1 NAS signaling connection means concatenation of NG connection via an N2 reference point for the 3GPP access and RRC connection via a Uu reference point or concatenation of NG connection via the N2 reference point for the non-3GPP access and the IPsec tunnel via an NWu reference point.

5GMM-IDLE mode: The UE is in the 5GMM-IDLE mode when there is no N1 NAS signaling connection between the UE and the network. The 5GMM-IDLE mode is corresponds to the CM-IDLE state.

Multiple SMS Transmission

SA2 agreement is derived as follows with respect to scenarios of multiple SMS transmission.

1) The MO SMS procedure over NAS in CM-IDLE is described above with reference to FIG. 11.

2) Mobile Terminated (MT) SMS over NAS in CM-IDLE

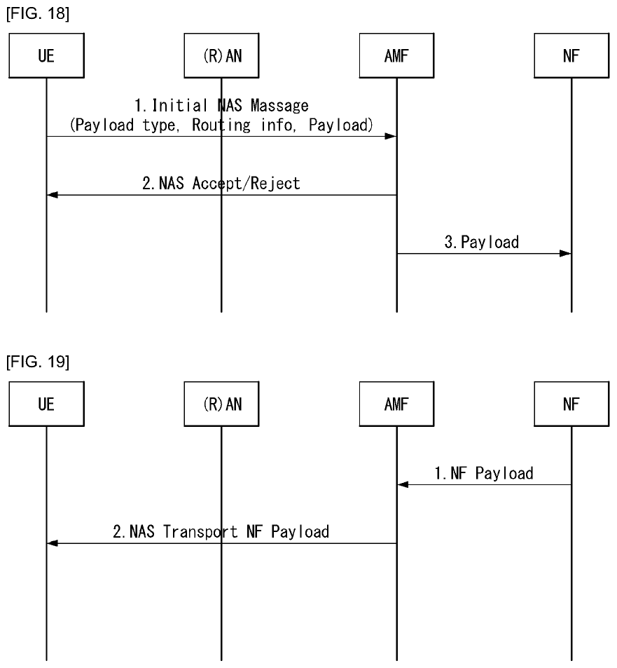

FIG. 20 illustrates an MT SMS procedure over NAS in a wireless communication system to which the present invention may be applied.

1-3. An MT SMS interaction among Service Centre (SC)/Short Message Service-Gateway Message Service Center (SMS-GMSC)/UDM follows TS 23.040.

4. The SMSF sends an SMS paging request to the AMF over N20. The SMS message includes IMSI and SMS-MT indications. The AMF pages the UE. The UE responds to paging by a service request procedure.

After the NAS connection is established between the AMF and the UE, the AMF transmits the message to the SMSF over N20 so that the SMMF transports the MT SMS. In order to allow the SMF to generate an accurate charging record, the AMF encapsulates the IMEISV, a local time zone, and current TAI and x-CGI of the UE as a part of a service request.

5. The SMSF transports the SMS message to be sent as defined in TS 23.040. The AMF encapsulates the SMS message and transmits the encapsulated SMS message to the UE over the NAS message. For an uplink unit data message toward the SMSF, the AMF also encapsulates the x-CGI and the TAI.

6. The UE returns the transport report as defined in TS 23.040. The transport report is encapsulated in the NAS message and sent to the AMF which is transported to the SMSF. When there is no SMS to be sent any longer, the SMSF requests termination of the SMS transaction to the AMF.

7. The SMSF sends the transport report as defined in TS 23.040.

Case Where AMF May Not Send SM Message to SMF

1. An abnormal case at the network side is described below in current TR 24.890.

The abnormal case in the AMF described below is identified.

a) The AMF does not have a PDU session routing context for the PDU session identifier (ID) of the UL SM MESSAGE TRANSPORT message and the request type ID of the UL SM MESSAGE TRANSPORT message is set to “initial request”, and the SMF selection is unsuccessful.

b) The AMF does not have a PDU session routing context for the PDU session ID of the UL SM MESSAGE TRANSPORT message, the request type ID of the UL SM MESSAGE TRANSPORT message is set to an “existing PDU session”, and a subscription context of the user obtained from the UDM does not include a SMF ID corresponding next.

1) DNN of the UL SM MESSAGE TRANSPORT message (case where the NN is included within the NAS SM MESSAGE TRANSPORT message); or

2) Basic DNN (case where the DNN is not included within the NAS SM MESSAGE TRANSPORT message)

When the request type is not provided by the UE, a similar error may occur.

When the processing for such a case is undefined, the failure is based on permanent case (e.g., the requested DNN is not used in the network), and the SM message is resent, the UE will resend the SM message in a new UL SM MESSAGE TRANSPORT message and the AMF will repeat the SMF selection, but the same failure will be repeated.

2. An available solution is as follows.

1) Alternative-1

The UE initiated NAS transport procedure is extended to the UL SM MESSAGE TRANSPORT ACCEPT message or the UL SM MESSAGE TRANSPORT REJECT message and is a message which the AMF sends at the time of receiving and processing the UL SM MESSAGE TRANSPORT REQUEST message. Only a single UE initiated NAS transport procedure may be operated within a given time.

When the AMF may transport a 5GSM message in the UL SM MESSAGE TRANSPORT REQUEST message, the AMF sends the UL SM MESSAGE TRANSPORT ACCEPT message.

When the AMF may not transport the 5GSM message in the UL SM MESSAGE TRANSPORT REQUEST message, the AMF sends the UL SM MESSAGE TRANSPORT REJECT message. The UL SM MESSAGE TRANSPORT REJECT message includes the cause.

When certainty is provided to the SM transport layer, the 5GSM message need not be resent in the 5GSM procedure.

When the transport of the 5GSM message is unsuccessful, it is regarded that the 5GSM procedure is not successfully completed.

2) Alternative-2

When the AMF may not transport the 5GSM message in the UL SM MESSAGE TRANSPORT message, the AMF sends a 5GMM STATUS message. The 5GMM STATUS message includes a 5GMM message container IE containing the UL SM MESSAGE TRANSPORT message and the cause.

When the UE receives the 5GMM STATUS message with the 5GMM message container IE containing the UL SM MESSAGE TRANSPORT message and the cause, the 5GMM layer informs the 5GSM layer that the 5GSM message is not transported.

Based on the fact that the 5GSM message is not transported, in the 5GSM procedure, any retransmission of the 5GSM message will also be stopped and the 5GSM procedure is regarded to be completed unsuccessfully.

3) Alternative-3

The SMF for rejection is configured in the AMF.

The AMF routes any SM message of which transport may not be routed to the SMF for rejection. The SMF rejects the 5GSM request message as an appropriate 5GSM response message.

4) Alternative-4

When the AMF may not select the SMF, any operation is not also performed and retransmission is maintained.

3. Proposal

The existing procedure requires only one NAS message whereas alternative-1 requires two NAS messages for transport. Alternative-3 requires placement of the SMF for a situation when the SMF selection is unsuccessful. In this case, the SMF need not perform an overall operation and only needs to reject the 5GSM message transmitted from the UE. Alternative-4 does not also solve any problem.

Accordingly, Alternative-2 is proposed. Alternative-2 does not require an additional message for transporting the NAS. Alternative-2 does not require the placement of the SMF to be used when the SMF selection in the AMF is unsuccessful. Alternative-2 ensures that the UE does not continue retransmission of the 5GSM message when the 5GSM message may not be transported.

4. The above proposal is agreed and TR 24.890 is thus changed as below.

a) When the AMF does not have a PDU session routing context for the PDU session ID of the UL SM MESSAGE TRANSPORT message and the request type ID of the UL SM MESSAGE TRANSPORT message is set to “initial request”, and the SMF selection is unsuccessful, the AMF generates the 5GMM STATUS message. The AMF sets the 5GMM message container IE in the 5GMM STATUS message to the UL SM MESSAGE TRANSPORT message. The AMF sets a cause IE of the 5GMM STATUS message as the cause indicating the cause of the failure. The AMF transmits the 5GMM STATUS message to the UE.

b) When the AMF does not have a PDU session routing context for the PDU session ID of the UL SM MESSAGE TRANSPORT message, the request type ID of the UL SM MESSAGE TRANSPORT message is set to an “existing PDU session”, and a subscription context of the user obtained from the UDM does not include a SMF ID corresponding next,

1) DNN of the UL SM MESSAGE TRANSPORT message (case where the DNN is included within the NAS SM MESSAGE TRANSPORT message); or

2) Basic DNN (case where the DNN is not included within the NAS SM MESSAGE TRANSPORT message)

The AMF generates the 5GMM STATUS message. The AMF sets the 5GMM message container IE in the 5GMM STATUS message to the UL SM MESSAGE TRANSPORT message. The AMF sets a cause IE of the 5GMM STATUS message as the cause indicating the cause of the failure. The AMF transmits the 5GMM STATUS message to the UE.

c) When the AMF does not have a PDU session routing context for the PDU session ID of the UL SM MESSAGE TRANSPORT message and the request type UE of the UL SM MESSAGE TRANSPORT message is not provided, the AMF generates the 5GMM STATUS message. The AMF sets the 5GMM message container IE in the 5GMM STATUS message to the UL SM MESSAGE TRANSPORT message. The AMF sets a cause IE of the 5GMM STATUS message as the cause indicating the cause of the failure. The AMF transmits the 5GMM STATUS message to the UE.

d) When the AMF has the PDU session routing context for the PDU session ID of the UL SM MESSAGE TRANSPORT message, the request type IE of the UL SM MESSAGE TRANSPORT message is set to “initial request”, and the AMF does not receive a reallocation request indication, the AMF needs to transport the SM message in the UL SM MESSAGE TRANSPORT, the PDU session ID, single network slice selection assistance information (S-NSSAI) (when received), DNN (when received), and the request type IE toward the SMF ID of the PDU session routing context.

e) When the AMF has the PDU session routing context for the PDU session ID of the UL SM MESSAGE TRANSPORT message, the PDU session routing context indicates that the PDU session is an emergency PDU session, and the request type IE of the UL SM MESSAGE TRANSPORT message is set to “initial emergency request”, the AMF needs to transport the SM message in the UL SM MESSAGE TRANSPORT, the PDU session ID, S-NSSAI (when received), DNN (when received), and the request type IE toward the SMF ID of the PDU session routing context.

f) When the AMF has the PDU session routing context for the PDU session ID of the UL SM MESSAGE TRANSPORT message, the request type IE of the UL SM MESSAGE TRANSPORT message is set to “initial request”, and the AMF receives a reallocation request indication indicating that the SMF is to reallocated from the SMF, and the PDU session routing context includes a reallocated SMF ID, the AMF needs to transport the SM message in the UL SM MESSAGE TRANSPORT, the PDU session ID, single network slice selection assistance information (S-NSSAI) (when received), DNN (when received), and the request type IE toward the reallocated SMF ID of the PDU session routing context.

When receiving the 5GMM STATUS message including the 5GMM message container IE including the UL SM MESSAGE TRANSPORT message, the UE transports a non-transport indication together with the SM message of the UL SM MESSAGE TRANSPORT message.

4. The abnormal case at the UE side is described as below.

a) Case where Tz expires

b) when receiving the non-transport message together with a PDU SESSION RELEASE REQUEST message including a PTI IE set to an allocated PTI value, the UE stops timer Tz, releases the allocated PTI value, and regards that the PDU session is not released.

Coding of NAS Transport Message for Alternative-2

The UL NAS TRANSPORT message transports a payload and related information to the network.

Table 1 shows UL NAS TRANSPORT message contents.

TABLE 1

| IEI | Information Element | Type/Reference | Presence | Format | Length |
|---|---|---|---|---|---|
| | Extended protocol | Extended protocol | M | V | 1 |
| | discriminator | discriminator | | | |
| | | 6.6.6.2 | | | |
| | Security header type | Security header type | M | V | ½ |
| | | 6.6.6.3 | | | |
| | Spare half octet | Spare half octet | M | V | ½ |
| | | 6.6.6.5 | | | |
| | UL NAS TRANSPORT | Message type | M | V | 1 |
| | message identity | 6.6.6.7 | | | |
| | Payload container type | Payload container type | M | V | ½ |
| | | 8.7.p | | | |
| | Spare half octet | Spare half octet | M | V | ½ |
| | | 6.6.6.5 | | | |
| | Payload container | Payload container | M | LV-E | 3- |
| | | 8.7.q | | | 65537 |
| r | PDU session ID | PDU session ID in 5GMM | C | TBD | 1 |
| | | 8.7.r | | | |
| a | Request type | Request type | O | TV | 1 |
| | | 8.7.6 | | | |
| b | S-NSSAI | S-NSSAI | O | TLV | 3-6 |
| | | 8.7.7 | | | |
| c | DNN | DNN | O | TLV | 3-102 |
| | | 8.7.8 | | | |
| s | Additional information | Additional information | O | TLV | 3-n |
| | | 8.7.s | | | |

In Table 1, the information element (IE) represents a name of the information element. ‘M’ in a Presence field as a mandatory represents an IE included in the message, and ‘O’ as an optional IE represents an IE that may be included in the message or not included in the message, and ‘C’ represents as a conditional IE represents an IE included in the message only when a specific condition is satisfied.

Referring to Table 1, when the payload container type IE is set to “N1 SM information”, the UE encapsulates the PDU session ID IE.

When the PDU session ID IE is included, the UE may encapsulate the request type IE.

When the request type IE is set to “initial request”, the UE may encapsulate the S-NSSAI IE.

When the request type IE is set to “initial request”, the UE may encapsulate a DNN ID.

When the payload container type IE is set to an “LTE Positioning Protocol (LPP) message container”, the UE may encapsulate the Additional information IE.

The DL NAS TRANSPORT message transports the payload and related information to the UE.

Table 2 shows DL NAS TRANSPORT message contents.

TABLE 2

| IEI | Information Element | Type/Reference | Presence | Format | Length |
|---|---|---|---|---|---|
| | Extended protocol | Extended protocol | M | V | 1 |
| | discriminator | discriminator | | | |
| | | 6.6.6.2 | | | |
| | Security header type | Security header type | M | V | ½ |
| | | 6.6.6.3 | | | |
| | Spare half octet | Spare half octet | M | V | ½ |
| | | 6.6.6.5 | | | |
| | DL NAS TRANSPORT | Message type | M | V | 1 |
| | message identity | 6.6.6.7 | | | |
| | Payload container type | Payload container type | M | V | ½ |
| | | 8.7.p | | | |
| | Spare half octet | Spare half octet | M | V | ½ |
| | | 6.6.6.5 | | | |
| | Payload container | Payload container | M | LV-E | 3- |
| | | 8.7.q | | | 65537 |
| r | PDU session ID | PDU session ID in 5GMM | C | TBD | 1 |
| | | 8.7.r | | | |
| s | Additional information | Additional information | O | TLV | 3-n |
| | | 8.7.s | | | |

Referring to Table 2, when the payload container type IE is set to “N1 SM information”, the AMF encapsulates the PDU session ID IE.

When the payload container type IE is set to an “LTE Positioning Protocol (LPP) message container”, the AMF may encapsulate the Additional information IE.

Hereinafter, the IE included in the UL NAS TRANSPORT message and the DL NAS TRANSPORT message described above will be described in more detail.

1) Request Type

A purpose of the request type IE is to indicate the type of PDU session establishment.

The request type IE is coded as shown in Table 3 below and the request type is a type 1 information element.

Table 3 shows the request type IE.

TABLE 3

| Request type value (octet 1, bit 1 to bit 4) | | | | |
|---|---|---|---|---|
| Bits | | | | |
| 4 | 3 | 2 | 1 | |
| 0 | 0 | 0 | 1 | initial request |
| 0 | 0 | 1 | 0 | existing PDU session |

All other values are reserved.

Bits 5 to 8 of octet 1 represent a request type IE identity (1E1) and bits 1 to 4 of octet 1 represent the request type value.

2) S-NSSAI

The purpose of the S-NSSAI IE is to identify a network slice.

The S-NSSAI IE is coded as shown in Table 4 below. The S-NSSAI IE is type 4 IE having a length of 3 octets or a length of 6 octets. When octet 4 is included, octets 5 and 6 are also included.

Table 4 shows the S-NSSAI IE.

TABLE 4

Slice/service type (SST) (octet 3)
Slice differentiator (SD) (octets 4 to 6)

Octet 1 represents the S-NSSAI IEI and octet 2 represents the length of the S-NSSAI contents.

3) DNN

The purpose of the DNN IE is to identify a data network.

The DNN is type 4 information element having a minimum length of 3 octets and a maximum length of 102 octets.

Octet 1 represents a DNN IEI, octet 2 represents the length of the DNN contents, and octets 3 to n represent a DNN value.

4) Payload Container Type

The payload container type IE indicates the type of payload included in the payload container IE.

The payload container type IE is coded as shown in Table 5 below and is type 1 information element having a length of ½ octet.

Table 5 shows the payload container type IE.

TABLE 5

| Payload container type value (octet 1, bit 1 to bit 4) | | | | |
|---|---|---|---|---|
| Bits | | | | |
| 4 | 3 | 2 | 1 | |
| 0 | 0 | 0 | 1 | N1 SM information |
| 0 | 0 | 1 | 0 | SMS |
| 0 | 0 | 1 | 1 | LPP message container |

All other values are reserved.

5) Payload Container

The purpose of the payload container IE is to transport the payload.

The payload container type IE is coded as shown in Table 6 below and is type 6 information element having a minimum length of 3 octets and a maximum length of 65537 octets.

Table 6 shows the payload container type IE.

TABLE 6

Payload container contents (octets 3 to n); a maximum length of
65535 octets

6) PDU Session ID

The PDU session ID in the 5GMM IE indicates the identity of the PDU session.

7) Additional Information

The purpose of the additional information IE is to provide additional information to the higher layer in association with an NAS transport mechanism.

The additional information is coded as shown in Table 7 below and is type 4 information element having a minimum length of 3 octets.

Table 7 shows the payload container type IE.

TABLE 7

Additional information value (octets 3 to n)
Coding of the additional information value is dependent on a
location services (LCS) application.

Supporting MM Status Message in 5GS

The purpose of the 5GMM STATUS procedure is to report a detected specific error status in real time within the 5GMM STATUS message when receiving 5GMM protocol data in the UE. The 5GMM STATUS message may be transmitted by the AMF and the UE.

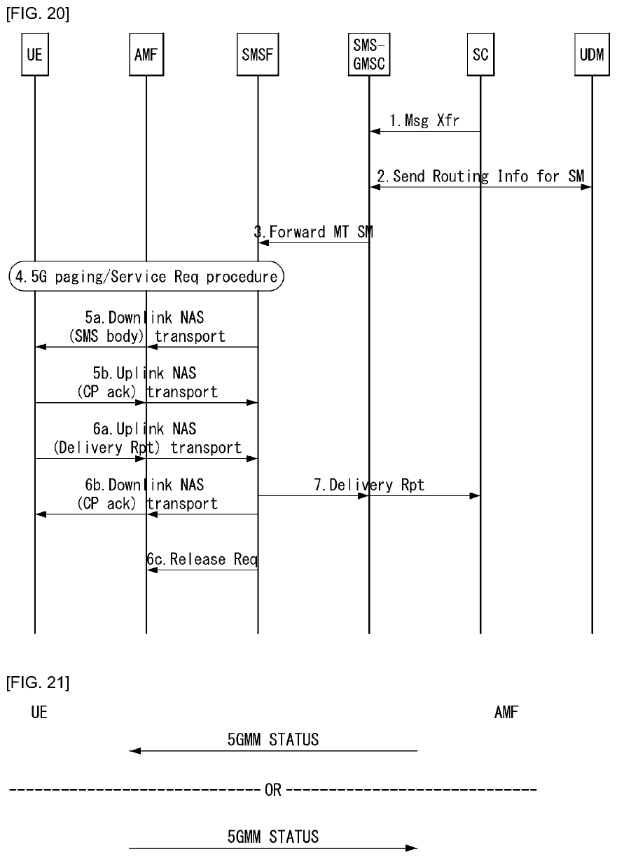

FIG. 21 is a diagram illustrating a 5GMM status procedure in a wireless communication system to which the present invention may be applied.

When the UE receives the 5GMM STATUS message, a status of the UE is not switched and a specific operation is not performed. According to implementation, a local operation may be performed by the UE at the time of receiving the 5GMM STATUS message.

When the AMF receives the 5GMM STATUS message, the status of the UE is not switched and the specific operation is not performed. According to implementation, the local operation may be performed by the AMF at the time of receiving the 5GMM STATUS message.

Table 8 shows 5GMM STATUS message contents.

TABLE 8

| IEI | Information Element | Type/Reference | Presence | Format | Length |
|---|---|---|---|---|---|
| | Extended protocol | Extended protocol | M | V | 1 |
| | discriminator | discriminator | | | |
| | | 6.6.6.2 | | | |
| | Security header type | Security header type | M | V | ½ |
| | | 6.6.6.3 | | | |
| | Spare half octet | Spare half octet | M | V | ½ |
| | | 6.6.6.4 | | | |
| | 5GMM STATUS message | Message type | M | V | 1 |
| | type | 6.6.6.6 | | | |
| | 5GMM cause | 5GMM cause | M | V | 2 |
| | | 8.7.1 | | | |

NAS Transport Message Processing Method

Problem 1) As described above with reference to FIG. 7, Subclause 14.13.3.4 of 3GPP TS 23.502 defines a method for transmitting the SMS using the NAS message. In this case, according to the transmission method, a two step approach and a one step approach are provided.

Here, the two step approach refers to a method in which the UE, which is in the CM-IDLE state, performs the service request procedure for switching to the CM-CONNECTED state and then transmits the SMS using a separate message. On the other hand, the one step approach refers to a method in which the UE in the CM-IDLE state transmits an initial NAS message including an SMS message when transmitting the initial NAS message.

The one step approach is also used in existing EPCs and an example of the one step approach is described below.

1. Attach request message with PDN connection request

2. Control plane service request message for Control Plane (CP) Cellular Internet of Things (CIoT) EPS optimization

A. EPS Session Management (ESM) message container

B. NAS message container

In the case of 1) and 2-A) described above, an initial NAS message (i.e., a mobility management (MM) message) is transmitted, which piggybacks an ESM message container that may include a Signaling Management (SM) message. Further, in the case of 2-B) described above, the initial NAS message (MM message) is transmitted which piggybacks the NAS message container which may include the SMS message.

According to 3GPP TS 23.502, since piggybacking of a PDU session establishment request when transmitting a registration request is described as being scheduled to be defined later, definition of scheme 1) described above is not determined at present in 5G.

However, as described above, as well as the SMS, a NAS transport message of a form which may include the NAS message for the SM signaling or another service is proposed.

The NAS transport message includes the following information/message.

Payload: Including corresponding NAS message (e.g., NAS message for SMS or SM or MM or another service)

Payload type (e.g., SMS or SM or MM or another service): Including type information of the NAS message included in the payload

Routing info: Routing information for transporting the NAS message included in the payload to an appropriate network function (NF)

Further, as described above, a procedure for transmitting the NAS transport message is proposed. FIG. 16 above illustrates the NAS transport procedure performed by the UE in the CM-CONNECTED mode. The details of the procedure are as follows.

Step 1) The UE transmits to the AMF the NAS transport message including the payload and the payload type, and the routing information.

Step 2) When the AMF is not allowed to transmit the payload included in the NAS transport message or another error is detected, the AMF does not transport the corresponding payload and transmits to the UE a NAS reject message including an appropriate cause.

In this case, ‘when transmission of the payload is not allowed or another error is detected’, the AMF transmits the NAS reject message to the UE without transporting the corresponding payload. However, even if the AMF determines the reject, for the AMF to transport the payload to another NF and receive a feedback for the payload and then transport the feedback to the UE, including feedback with rejection/acceptance may assist the operation of the UE afterwards.

The operation related to the UE requested PDN connectivity procedure not accepted by the network has been described above. According to the EPC related art, a rejection when the PDN connection request message is transmitted together with the attach request message is described. In this case, both rejections of the MM message (i.e., attach request message) and the SM message (PDN connection request message) are returned to the UE. In this case, the rejection cause of the SM message assists the later operation of the UE. An example thereof is described below.

“If the PDN CONNECTIVITY REJECT message is due to an ESM failure notified by the EPS Mobility Management (EMM) layer (i.e., EMM Cause #19 “ESM Failure” included in the ATTACH REJECT message), the UE may encapsulate another Access Point Name (APN) in the PDN CONNECTIVITY REQUEST message.”

According to the above description, the UE may not retry the same APN due to ESM reject cause and may request unnecessary retry signaling by requesting the PDN connection to another APN again.

In addition, in the case of the AMF, when a message which needs to be transmitted to another NF is included in the payload of the N1 message received from the UE, there is a problem that it is unclear how to process the message (e.g., a processing/response sequence of each message).

Problem 2) According to ‘Alternative 2’ described above, the 5GMM STATUS message, which the AMF transmits to the UE, is defined to include the 5GSM message and the cause.

However, there is a problem that when the 5GMM STATUS message includes the 5GSM message, overhead occurs. Further, if the AMF transports the SM message to the SMF, but does not receive the response, there is a problem in that a burden that the AMF should continuously store the transported SM message against a case where the AMF may not receive the response whenever transporting the SM message to the SMF occur.

In order to solve the problem described above, the present invention proposes an efficient operation of the AMF that receives, when the NAS transport message or the initial NAS message piggybacks/includes another NAS message (e.g., 5GS Signaling Management (5GSM) message, SMS, LTE Positioning Protocol (LPP) message, or a transparent container), the corresponding NAS transport message or initial NAS message.

The AMF may operate as follow when receiving the initial NAS message that piggybacks the NAS transport message or a message to be transported to another NF.

The AMF may determine whether to transport the payload by checking the payload type and the routing info and also determine whether to reject or accept the NAS. That is, the AMF may determine which scheme is to be applied among cases to be described below by checking the corresponding payload type and routing info (see Example 1-2).

In the case of transporting the payload, the operation of the AMF that receives the NAS transport message from the UE may be classified into the following cases according to the AMF response (rejection or acceptance).

In this specification, for convenience of description, the response (i.e., a response to a NAS request (i.e., MM request) of the UE) which the AMF transports to the UE) is referred to as an MM response. Further, hereinafter, in describing the present invention, the network function (NF) refers to SMF, SMSF, PCF, UDM, AUSF, etc., where the AMF and the interface exist. Further, hereinafter, in describing the present invention, the response may be rejected or accepted unless otherwise described. In this case, in the case of the rejection, the response may include the reject cause and a back-off timer and in the case of the acceptance, the response may include NF information or an accepted list.

### [Example 1-1] Detailed Operation of AMF for Each Case

Case 1) The AMF transports to the NF the payload in the UL NAS TRANSPORT message received from the UE. In addition, after the AMF waits for the response to the payload from the NF to which the payload is transported without immediately transmitting the MM response (i.e., MM rejection or MM acceptance), the AMF may transmit to the UE the response to the corresponding payload together the MM response (MM rejection or MM acceptance).

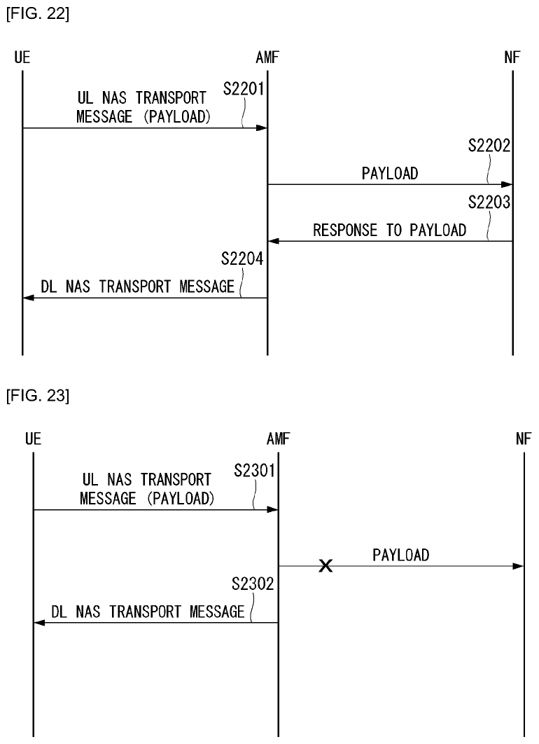

FIG. 22 is a diagram illustrating an NAS transport procedure according to an embodiment of the present invention.

Referring to FIG. 22, a UE (e.g., a UE in a connected mode) initiates the NAS transport procedure by transmitting the UL NAS TRANSPORT message to the AMF (S2201).

The NAS transport procedure is used for transporting the payload between the UE and the AMF. The payload transported in the NAS TRANSPORT message may be identified by the payload type in the NAS TRANSPORT message and may include one of the following:

5GS Signaling Management (5GSM) message

SMS

LTE Positioning Protocol (LPP) message

Transparent container

In addition, the NAS TRANSPORT message may include related information (e.g., PDU session information for a 5GSM message payload) in addition to the payload described above. Further, the NAS TRANSPORT message may include associated payload routing information.

The AMF transports the payload included in the UL NAS TRANSPORT message to the NF (S2202).

A. In the above operation, the AMF may transport the payload and a timer Taaaa in order to check whether to receive the response to the payload transported to the corresponding NF. In this case, it is preferable that the value of Taaaa is set to a value smaller than a timer value for monitoring when the UE transmits the MM request message (i.e., UL NAS TRANSPORT message).

B. When receiving the response (i.e., rejection or acceptance) to the payload from the corresponding NF (S2213), the AMF piggybacks the response to the corresponding payload to the MM response (i.e., DL NAS TRANSPORT message) and transmits the response to the UE (S2204).

In this case, in the case where the AMF starts the timer Taaaa as described above, when the response to the payload is received from the corresponding NF before the corresponding timer Taaaa expires, the AMF may piggyback the response to the corresponding payload to the MM response (i.e., DL NAS TRANSPORT message) and the transmit the response to the UE.

C. When the AMF may not receive the response (i.e., rejection or acceptance) to the payload from the corresponding NF, the AMF may piggyback a cause (e.g., there is no response from the NF) for notifying that the response may not be received to the MM response (i.e., DL NAS TRANSPORT message) and transmit the response to the UE (S2204).

In this case, in the case of a form in which the corresponding cause is included in the MM response (i.e., DL NAS TRANSPORT message), the corresponding cause may be included in a separate information element (IE) in the MM response (i.e., DL NAS TRANSPORT message) and notified to the UE.

Further, in the case where the AMF starts the timer Taaaa as described above, when the AMF may not receive the response (i.e., rejection or acceptance) to the payload from the corresponding NF until the corresponding timer Taaaa expires, the AMF may piggyback a cause (e.g., there is no response from the NF) for notifying that the response may not be received to the MM response (i.e., DL NAS TRANSPORT message) and transmit the response to the UE.

D. With B and C described above, the UE that receives the MM response (i.e., the DL NAS TRANSPORT message) may confirm the response (i.e., rejection or acceptance) of the AMF through the IE of the MM response and also confirm the status of the corresponding NF through a separate IE of the response (i.e., rejection or acceptance) to the payload of the corresponding NF piggybacked to the MM response.

Case 2) The AMF may transmit the MM response (MM rejection or MM acceptance) to the UE without transporting the payload in the UL NAS TRANSPORT message received from the UE.

FIG. 23 is a diagram illustrating an NAS transport procedure according to an embodiment of the present invention.

Referring to FIG. 23, a UE (e.g., a UE in a connected mode) initiates the NAS transport procedure by transmitting the UL NAS TRANSPORT message to the AMF (S2301).

As described above, the NAS TRANSPORT message may include any one of the following payloads.

5GS Signaling Management (5GSM) message

SMS

LTE Positioning Protocol (LPP) message

Transparent container

The AMF may transmit the MM response (i.e. DL NAS TRANSPORT message) to the UE without transporting the payload included in the UL NAS TRANSPORT message to the NF (S2302).

A. In this case, the AMF may recognize the status of the NF before or at the time of receiving the UL NAS TRANSPORT message from the UE.

In this case, as an example of the recognition method, the AMF may know the status by receiving direct explicit signaling for notifying the status thereof from the NF or by an implicit method without transmitting the response to another signaling by the NF.

B. When the AMF recognizes of the status of the NF and determines that the transport of the payload is unnecessary, the AMF may piggyback a cause (i.e., congestion or no response from the NF) for notifying that the AMF recognizes of the status of the NF and determines that the transport of the payload is unnecessary to the MM response (i.e., DL NAS TRANSPORT message) and transport the cause to the UE.

In the case of a form in which the cause is included in the MM response (i.e., DL NAS TRANSPORT message), the cause may be included in the IE of the MM response (i.e., DL NAS TRANSPORT message) as a separate IE and notified to the UE. For example, in the case of congestion, if there is a message received in the NF, the message may be piggybacked to the MM response (i.e., DL NAS TRANSPORT message) and transmitted to the UE. Alternatively, the cause indicating the congestion, the back-off timer, and a target (e.g., an identifier of the APN, the DN, or the NF) of the congestion may be included in the MM response and transmitted to the UE.

The reason when the AMF determines that the transport of the payload is unnecessary may include any one of the following cases.

Case where the corresponding NF (a transport destination of the payload) is congested

Case where the corresponding NF does not normally operate

Case where the payload is not transported to the corresponding NF (e.g., case where there is no correct NF)

C. The UE receiving the MM response (i.e., the DL NAS TRANSPORT message) may confirm the response (i.e., rejection or acceptance) of the AMF through the IE of the MM response or also confirm the status of the corresponding NF through the separate IE of the MM response.

Case 3) The AMF transports to the NF the payload in the UL NAS TRANSPORT message received from the UE. In addition, the AMF may transmit the MM response (MM rejection or MM acceptance) to the UE without waiting for the response from the NF to which the payload is transported.

FIG. 24 is a diagram illustrating an NAS transport procedure according to an embodiment of the present invention.

Referring to FIG. 24, a UE (e.g., a UE in a connected mode) initiates the NAS transport procedure by transmitting the UL NAS TRANSPORT message to the AMF (S2401).

As described above, the NAS TRANSPORT message may include any one of the following payloads.

5GS Signaling Management (5GSM) message

SMS

LTE Positioning Protocol (LPP) message

Transparent container

The AMF transports the payload included in the UL NAS TRANSPORT message to the NF (S2402).

The AMF may transmit the MM response (i.e., DL NAS TRANSPORT message) to the UE (S2403).

In respect to a difference from 2) described above, in this case, the MM response (DL NAS TRANSPORT message) may not include the response or information for the payload from the NF to which the payload is transported. That is, the AMF may operate as described above regardless of whether to recognize status information of the NF.

For example, when the AMF transmits the MM response to the UL NAS TRANSPORT message transmitted by the UE and then maintains the UE state in the 5GMM-CONNECTED mode without immediately switching to 5GMM-IDLE, the AMF first transmits the MM response to the UE and then the AMF may transport the response to the UE in the 5GMM-CONNECTED mode upon receiving the response to the payload from the NF.

For example, the following operations may be performed.

In the EPC in the related art, when the CIoT UE transmits control plane (CP) data, a release assistance indication operation may be referred.

i) The AMF that receives ‘no further uplink or downlink data transmission is expected’ may transport the message included in the payload to the corresponding NF. In addition, the AMF may immediately perform an N1 response procedure (e.g., S1 release procedure). In this case, when checking whether the message is normally transported to the corresponding NF is required, the AMF may receive a response message from the corresponding NF and then indicate the received response message to an N1 response message and transport the response message to the UE.

ii) The AMF that receives ‘only a single uplink data transmission (e.g., acknowledgement or response to uplink data) and no further uplink data transmission subsequent to the uplink data transmission is expected’ or ‘No information available’ may first transmit the MM response (e.g., service acceptance message) to the UE. Thereafter, when receiving the response message from the NF, the AMF may transport the response message to the UE in the 5GMM-CONNECTED mode state.

Further, when performing a registration (update) procedure, the AMF may immediately switch to the 5GMM-IDLE mode or maintain the 5GMM-CONNECTED mode after performing the registration (update) procedure.

Case 4) When the UE encapsulates the payload in the UL NAS TRANSPORT message, the UE may indicate whether the response to the payload is required/expected when the corresponding payload is transmitted to the corresponding NF.

In this case, when the AMF receives the UL NAS TRANSPORT message, the AMF confirms the payload and payload related information. In addition, the AMF confirms the indication for whether the response message to the payload is required/expected from the target NF, and as a result, the AMF may operate as follows.

A. When the indication for whether the response message to the payload is required/expected from the target NF is ‘the response message is required (expected)’, the AMF may operate according to case 1), case 2), or case 3) described above.

In this case, the UE may start the timer with the transmission of the UL NAS TRANSPORT message including the payload in order to determine whether transmission of each payload is successful. In addition, when the UE receives the response to the payload, the UE may stop the timer and recognize that the payload is successfully transmitted to the NF. On the other hand, when the response message is not received from the corresponding NF until the timer expires, the UE may transmit the message transmitted in the corresponding payload again.

B. When the indication for whether the response message to the payload is required/expected from the target NF is ‘the response message is not required (expected)’, the AMF may transport the payload to the NF and not wait for the response message from the NF.

When an indication for all payloads including the UL NAS TRANSPORT message is “response message is not required (expected)’, the AMF may immediately transmit the MM response message to the UE. In this case, when the UE receives the MM response message from the AMF, the UE may check whether the message in the payload transmitted to the NF is successfully transmitted. To this end, the MM response message may include an indication or IE indicating whether the AMF successfully transports the message included in the payload to the NF.

The AMF may encapsulate an indication (payload forwarding is delivered, payload forwarding is not delivered, etc.) indicating whether to transport the payload to the NF in the MM response message (for each payload). In this case, in the case where payload forwarding is Not delivered, the cause may be further included.

C. Instead of the indication, the AMF may determine whether ‘the response message is required (expected)’ by using the payload type IE.

In the following case, the AMF may determine that the response message is required from the target NF for the payload.

In case where the payload is the SM message, for example, Payload type IE=“N1 SM information”

In case where the payload is the SMS message, for example, Payload type IE=“SMS”

On the contrary, in the following case, the AMF may determine that the response message is not required from the target NF for the payload.

In case where the payload is a protocol message (e.g., LTE Positioning Protocol (LPP) message or LoCation Services application for transmitting a position service message) from various applications, for example, Payload type IE=“application”

The above example represents a message transmitted through a general transport procedure of the NAS message in the EPC in the related art.

In case where the payload is single (CP) UL transmission, for example, Payload type IE=“single (CP) uplink data” or “single (CP) uplink signaling”

The case may correspond to a case where a release assistance indication (i.e., ‘No further uplink or downlink data transmission subsequent to the uplink data transmission is expected’) is included when the CIoT transmits CP data in the related art suitable for the above example, for example, the EPC in the related art. In this case, the case means a case where a response to transmission of the CP data from the NF (SGW) is not required.

Further, a concept of case 4) described above may be applied even to a downlink message which the NF transmits to the UE.

That is, the message which the NF transmits to the UE may be included in the payload in the message which the NF transmits to the AMF and an indication (e.g., an indication for requesting a response (e.g., acknowledgement) to the payload from the UE) according to case 4) or the payload type IE may be included. In this case, the AMF may determine whether the UE needs to transmit the response message to the NF/whether the NF expects the response message of the UE through the indication according to case 40 or the payload type IE.

The information may be used for the AMF to determine whether to switch the UE to the 5GMM-IDLE mode after transporting the message to the UE. When transmission of the response message to the NF from the UE is not required/expected, the AMF may switch the UE to the 5GMM-IDLE mode after transporting the message transmitted from the NF to the UE. That is, the AMF may perform a procedure for switching the UE to the 5GMM-IDLE mode.

For example, the AMF may transmit to the UE the DL NAS TRANSPORT message including a downlink message transmitted from the NF to the UE. In this case, when it is determined that the UE needs to provide the response to the downlink message from the downlink message (i.e., when it is indicated that the UE needs to transmit the response message to the NF or the NF expects the response message of the UE in the payload received from the NF), the AMF may encapsulate the indication that the UE needs to provide the response to the downlink message in the DL NAS TRANSPORT message. Therefore, the UE may encapsulate the response to the downlink message in the DL NAS TRANSPORT message received from the AMF in the UL NAS TRANSPORT message and transmit the response to the AMF. In this case, the response (i.e., the response to the downlink message) included in the UL NAS TRANSPORT message may correspond to the payload in the UL NAS TRANSPORT message which the UE transmits to the AMF.

In case 1) or case 2) described above, the UE may use the received response or status information of the NF for the following signaling. For example, when the corresponding NF or DN (or Data Network Name) (DNN)) is not congested or performs a normal operation, the UE may not temporarily use the NF or DN (DNN) (until the back-off timer is in operation or signaling is received that the back-off timer returns to the normal operation). In this case, in order to use the service through another NF or DN (DNN), the UE may perform slice change, AMF change, RAT change, PLMN change, etc.

### [Example 1-2] Determination Procedure for Discrimination Operation of AMF

An example and an operation order in which the AMF discriminates and applies case 1, case 2, case 3, and case 4 described above are described below.

1. The AMF may determine the target NF by confirming the payload type and routing information contained in the UL NAS TRANSPORT message.

2. When the AMF transmits the payload included in the UL NAS TRANSPORT message transmitted by the UE to the target NF, the AMF may confirm the indication for whether the response is required/expected from the target NF. That is, the AMF may perform case 4 of [Example 1-1] above.

Here, when the indication for the payload is set to ‘response message is required (expected)’, the AMF may perform the following operation. That is, the AMF may check to which case among case 1, case 2, and case 3 of [Example 1-1] the case corresponds and perform the operation of the corresponding case.

3. The AMF may determine whether the payload is transported by checking whether the AMF has the status information of the NF for the target NF.

In this case, when the AMF has the status information of the NF, the AMF may not transport the payload. In this case, the AMF may perform case 2 described above.

On the other hand, when there is no status information of the corresponding NF, the payload type may be checked to determine which one of case 1 or case 2 is selected in advance.

4. The AMF determines whether to immediately switch the UE to 5GMM-IDLE after transmitting the MM response message to determine whether to transmit the MM response message to the UE or whether to immediately transmit the MM response message to the UE after waiting for receiving the response message to the payload to the target NF.

In this case, when the AMF immediately switches the UE to the 5GMM-IDLE after the transmission of the MM response message and the response is required from the NF, case 1 may be performed in advance.

On the other hand, when the AMF does not immediately switch the UE to the 5GMM-IDLE after transmitting the MM response message, the AMF may first transmit the MM response message to the UE and then, when receiving the response message for the payload from the NF, the AMF may transport the response message to the payload to the UE in the 5GMM-CONNECTED state.

In this case, the AMF may encapsulate the indication (i.e., payload forwarding is delivered, payload forwarding is Not delivered) (indicating the indication for each payload) indicating whether the payload is transported to the NF to the UE in the MM response message. In the case where “payload forwarding is Not delivered’, the cause may also be included.

Upon receiving the indication, the UE may check whether the payload transmitted by the UE is successfully transported to the corresponding NF.

In this case, when the UE receives ‘payload is delivered (forwarded)’ for the transmitted payload, the UE may recognize that the message included in the corresponding payload is successfully transmitted to the corresponding NF and wait for the response from the NF when the response is required from the NF.

On the other hand, when the UE receives ‘payload is delivered (forwarded)’ for the transmitted payload, the UE may start a timer Tbbbb if the UE waits for the response message from the NF. Tbbbb may be stopped when the response message is received from the NF. When the UE does not receive the response message from the corresponding NF until Tbbbb expires, the UE may retransmit the message to the corresponding NF.

When the UE encapsulates the message to be transmitted to the NF in the UL NAS TRANSPORT message and transmits the message, in the case where the response to the payload from the corresponding NF is required/expected, the UE may start Txxxx at the time of transmitting the corresponding message (included in the UL NAS TRANSPORT message). In this case, when the UE receives ‘payload is delivered (forwarded)’ for the transmitted payload, the UE may stop Txxxx and start the Tbbbb. In this case, when the UE may not receive the response for the corresponding NF or the indication for the payload delivery/forwarding from the AMF until Txxxx expires, the UE may retransmit the corresponding message to the corresponding NF.

Further, when the UE receives ‘payload is not delivered (forwarded)’ for the payload transmitted thereby, the UE may recognize that the message included in the corresponding payload is not successfully transmitted to the corresponding NF and determine whether the message is retransmitted according to the cause. In this case, when the retransmission is allowed according to the cause, the UE may attempt to retransmit the message.

### [Example 1-3] Case Where the AMF Fails to Transport the SM Message to the SMF or Transports the SM Message to the SMF but Does Not Receive the Response

In the example, for convenience of description, a case where the SM message is included in the UL NAS TRANSPORT message and transmitted is primarily described as an example, but the present invention is not limited thereto.

In the example, in order to solve problem 2 described above, the operations for the MM response in Examples 1-1 and 1-2 above are proposed in more detail.

FIG. 25 is a diagram illustrating an NAS transport procedure according to an embodiment of the present invention.

Referring to FIG. 25, a UE (e.g., a UE in a connected mode) initiates the NAS transport procedure by transmitting the UL NAS TRANSPORT message to the AMF (S2501).

As described above, the NAS TRANSPORT message may include any one of the following payloads.

5GS Signaling Management (5GSM) message

SMS

LTE Positioning Protocol (LPP) message

Transparent container

In the case where the AMF fails to transport the payload included in the UL NAS TRANSPORT message to the NF (S2502). The AMF may transmit the MM response (i.e., DL NAS TRANSPORT message) to the UE (S2503).

As an example, when the AMF fails to transport the SM message (i.e., the payload in the UL NAS TRANSPORT message) to the SMF or transports the SM message to the SMF but fails to receive the response, the AMF may encapsulate a procedure transaction identity (PTI), a sequence number, or a PDU session identifier (ID) in the MM response (i.e., the response to the UL NAS TRANSPORT message) and transmit the PTI, the sequence number, or the PDU session ID to the UE.

In this case, a UL SM message (i.e., the payload included in the UL NAS TRANSPORT message) may not be included in the MM response message.

That is, in the form of one of the following options, the AMF may encapsulate the corresponding information in the MM response message and transmit the MM response message to the UE.

Option A) PTI and cause value; or

Option B) sequence number and cause value; or

Option C) PDU session ID and cause value

Here, the MM response message may be implemented as the DL NAS TRANSPORT message or a 5GMM STATUS message or a new 5GMM message. When the above-described options are implemented as the DL NAS TRANSPORT message, the SM message may not be included, and as a result, a payload container may be optionally changed.

Hereinafter, each option described above will be described in more detail.

Option A) When the procedure transaction identity (PTI) and the cause value are included in the MM response message, the PTI should be included in the UL NAS TRANSPORT message.

In this case, if the AMF receives the UL NAS TRANSPORT message and then fails to transport the SM message to the SMF or transports the SM message to the SMF but fails to receive the response to the SM message, the AMF may encapsulate the PTI value and the cause value (i.e., a value indicating a cause for the failure of the transport of the SM message) included in the UL NAS TRANSPORT message in the MM response message (i.e., the DL NAS TRANSPORT message or the 5GMM STATUS message, or a new 5GMM message) and transmit the PTI value and the cause value to the UE.

Table 9 shows the DL NAS TRANSPORT message according to an embodiment of the present invention.

TABLE 9

| IEI | Information Element | Type/Reference | Presence | Format | Length |
|---|---|---|---|---|---|
| | Extended protocol | Extended protocol | M | V | 1 |
| | discriminator | discriminator | | | |
| | | 6.6.6.2 | | | |
| | Security header type | Security header type | M | V | ½ |
| | | 6.6.6.3 | | | |
| | Spare half octet | Spare half octet | M | V | ½ |
| | | 6.6.6.5 | | | |
| | DL NAS TRANSPORT | Message type | M | V | 1 |
| | message identity | 6.6.6.7 | | | |
| | Payload container type | Payload container type | M | V | ½ |
| | | 8.7.p | | | |
| | Spare half octet | Spare half octet | M | V | ½ |
| | | 6.6.6.5 | | | |
| | Payload container | Payload container | O | LV-E | 3- |
| | | 8.7.q | | | 65537 |
| r | PDU session ID | PDU session ID in 5GMM | C | TBD | 1 |
| | | 8.7.r | | | |
| | PTI | Procedure transaction | M | V | 1 |
| | | identity | | | |
| | | 6.6.6.5 | | | |
| | Cause | 5GMM cause | O | V | 1 |
| | | 8.7.1 | | | |
| s | Additional information | Additional information | O | TLV | 3-n |
| | | 8.7.s | | | |

Referring to Table 9, the DL NAS TRANSPORT message may include a PTI IE and a Cause IE.

A detailed description of the PTI may be incorporated herein by reference in its entirety with reference to TS 24.007 V14.0.0.

The Cause IE may be set to ‘payload was not forwarded’.

A description of another IE which is not described in Table 9 above may be incorporated herein by reference in its entirety with reference to TS 24.501 V1.0.0.

Table 10 shows the 5GMM STATUS message according to an embodiment of the present invention.

TABLE 10

| IEI | Information Element | Type/Reference | Presence | Format | Length |
|---|---|---|---|---|---|
| | Extended protocol | Extended protocol | M | V | 1 |
| | discriminator | discriminator | | | |
| | | 6.6.6.2 | | | |
| | Security header type | Security header type | M | V | ½ |
| | | 6.6.6.3 | | | |
| | Spare half octet | Spare half octet | M | V | ½ |
| | | 6.6.6.5 | | | |
| | 5GMM STATUS message | Message type | M | V | 1 |
| | type | 6.6.6.7 | | | |
| | PTI | Procedure transaction | M | V | 1 |
| | | identity | | | |
| | | 6.6.6.5 | | | |
| | 5GMM cause | 5GMM cause | M | V | 2 |
| | | 8.7.1 | | | |

Referring to Table 10, the 5GMM STATUS message may include a PTI IE and a Cause IE.

A description of another IE which is not described in Table 10 above may be incorporated herein by reference in its entirety with reference to TS 24.501 V1.0.0.

Option B) When the sequence number and the cause value are included in the MM response message, the sequence number and the cause value may be implemented in the same method by replacing the PTI with the sequence number in Option A) described above.

The sequence number IE contains the sequence number of the NAS message.

Option C) may be implemented as follows.

Table 11 shows the DL NAS TRANSPORT message according to an embodiment of the present invention.

The DL NAS TRANSPORT message transports information associated with the message payload to the UE.

TABLE 11

| IEI | Information Element | Type/Reference | Presence | Format | Length |
|---|---|---|---|---|---|
| | Extended protocol | Extended protocol | M | V | 1 |
| | discriminator | discriminator | | | |
| | | 6.6.6.2 | | | |
| | Security header type | Security header type | M | V | ½ |
| | | 6.6.6.3 | | | |
| | Spare half octet | Spare half octet | M | V | ½ |
| | | 6.6.6.5 | | | |
| | DL NAS TRANSPORT | Message type | M | V | 1 |
| | message identity | 6.6.6.7 | | | |
| | Payload container type | Payload container type | M | V | ½ |
| | | 8.7.p | | | |
| | Spare half octet | Spare half octet | M | V | ½ |
| | | 6.6.6.5 | | | |
| | Payload container | Payload container | O | LV-E | 3- |
| | | 8.7.q | | | 65537 |
| r | PDU session ID | PDU session ID in 5GMM | C | TBD | 1 |
| | | 8.7.r | | | |
| | Cause | 5GMM cause | O | V | 1 |
| | | 8.7.1 | | | |
| s | Additional information | Additional information | O | TLV | 3-n |
| | | 8.7.s | | | |

Referring to Table 11, the DL NAS TRANSPORT message may include a PDU session ID IE and a Cause IE.

The PDU session ID IE may include an identity for identifying the PDU session.

The Cause IE may be set to ‘payload was not forwarded’.

Table 12 shows the 5GMM STATUS message according to an embodiment of the present invention.

The 5GMM STATUS message is transmitted by the UE or the network in order to report a specific error state.

TABLE 12

| IEI | Information Element | Type/Reference | Presence | Format | Length |
|---|---|---|---|---|---|
| | Extended protocol | Extended protocol | M | V | 1 |
| | discriminator | discriminator | | | |
| | | 6.6.6.2 | | | |
| | Security header type | Security header type | M | V | ½ |
| | | 6.6.6.3 | | | |
| | Spare half octet | Spare half octet | M | V | ½ |
| | | 6.6.6.5 | | | |
| | 5GMM STATUS message | Message type | M | V | 1 |
| | type | 6.6.6.7 | | | |
| | PDU session ID | PDU session ID in 5GMM | C | TBD | 1 |
| | | 8.7.r | | | |
| | 5GMM cause | 5GMM cause | M | V | 2 |
| | | 8.7.1 | | | |

Referring to Table 12, the 5GMM STATUS message may include a PDU session ID IE and a 5GMM Cause IE.

The PDU session ID IE may include an identity for identifying the PDU session.

The Cause IE may be set to ‘payload was not forwarded’.

Although in Example 1-3 described above, an implementation method for solving a message transport problem between the AMF and the SMF is described, the present invention is not limited thereto, and the same problem may also occur between the AMF and another NF. In this case, Option A) or Option B) described above may be applied.

Overview of Devices to Which Present Invention is Applicable

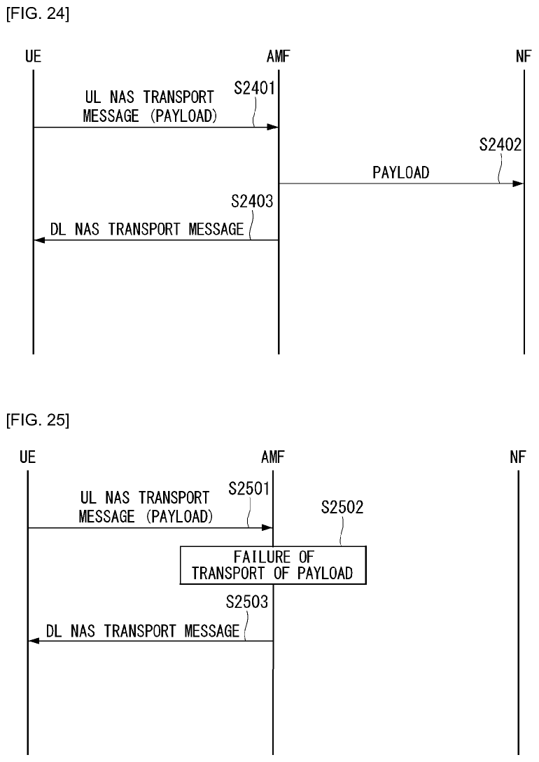

FIG. 26 illustrates a block diagram of a communication apparatus according to an embodiment of the present invention.

Referring to FIG. 26, a wireless communication system includes a network node 2610 and multiple user equipments 2620.

The network node 2610 includes a processor 2611, a memory 2612, and a communication module 2613 (transceiver). The processor 2611 implements a function, a process, and/or a method which are proposed in FIGS. 1 to 25 above. Layers of a wired/wireless interface protocol may be implemented by the processor 2611.

The memory 2612 is connected with the processor 2611 to store various pieces of information for driving the processor 2611. The communication module 2613 is connected with the processor 2611 to transmit and/or receive a wired/wireless signal. An example of the network node 2610 may correspond to a base station, AMF, SMF, UDF, etc. In particular when the network node 2610 is the base station, the communication module 2613 may include a radio frequency (RF) unit for transmitting/receiving the wireless signal.

The UE 2620 includes a processor 2621, a memory 2622, and a communication module (or RF unit) 2623 (transceiver). The processor 2621 implements a function, a process, and/or a method which are proposed in FIGS. 1 to 25 above. The layers of the wireless interface protocol may be implemented by the processor 2621. In particular, the processor may include an NAS layer and an AS layer. The memory 2622 is connected with the processor 2621 to store various pieces of information for driving the processor 2621. The communication module 2623 is connected with the processor 2621 to transmit and/or receive the wireless signal.

The memories 2612 and 2622 may be positioned inside or outside the processors 2611 and 2621 and connected with the processors 2611 and 2621 by various well-known means. Further, the network node 2610 (when the network node 2620 is the base station) and/or the UE 2220 may have a single antenna or multiple antennas.

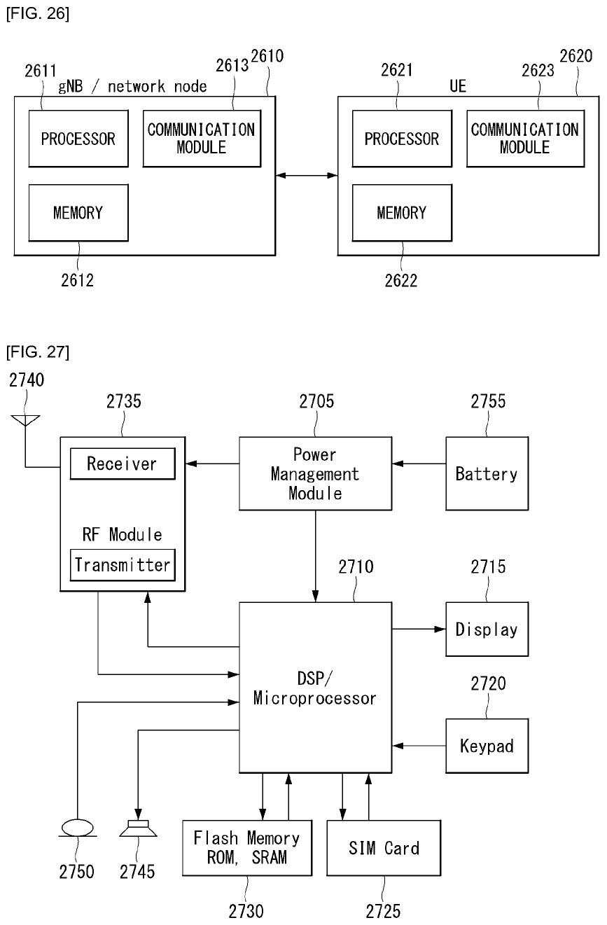

FIG. 27 illustrates a block diagram of a communication apparatus according to an embodiment of the present invention.

In particular, FIG. 27 is a diagram more specifically illustrating the UE of FIG. 26 above.

Referring to FIG. 27, the UE may be configured to include a processor (or a digital signal processor (DSP) 2710, an RF module (or RF unit) 2735, a power management module 2705, an antenna 2740, a battery 2755, a display 2715, a keypad 2720, a memory 2730, a subscriber identification module (SIM) card 2725 (this component is optional), a speaker 2745, and a microphone 2750. The UE may also include a single antenna or multiple antennas.

The processor 2710 implements a function, a process, and/or a method which are proposed in FIGS. 1 to 25 above. Layers of a wireless interface protocol may be implemented by the processor 2710.

The memory 2730 is connected with the processor 2710 to store information related to an operation of the processor 2710. The memory 2730 may be positioned inside or outside the processor 2710 and connected with the processor 2710 by various well-known means.

A user inputs command information such as a telephone number or the like by, for example, pressing (or touching) a button on the keypad 2720 or by voice activation using the microphone 2750. The processor 2710 receives such command information and processes to perform appropriate functions including dialing a telephone number. Operational data may be extracted from the SIM card 2725 or the memory 2730. In addition, the processor 2710 may display command information or drive information on the display 2715 for the user to recognize and for convenience.

The RF module 2735 is connected with the processor 2710 to transmit and/or receive an RF signal. The processor 2710 transfers the command information to the RF module 2735 to initiate communication, for example, to transmit wireless signals constituting voice communication data. The RF module 2735 is constituted by a receiver and a transmitter for receiving and transmitting the wireless signals. The antenna 2740 functions to transmit and receive the wireless signals. Upon receiving the wireless signals, the RF module 2735 may transfer the signal for processing by the processor 2710 and convert the signal to a baseband. The processed signal may be converted into to audible or readable information output via the speaker 2745.

In the embodiments described above, the components and the features of the present invention are combined in a predetermined form. Each component or feature should be considered as an option unless otherwise expressly stated. Each component or feature may be implemented not to be associated with other components or features. Further, the embodiment of the present invention may be configured by associating some components and/or features. The order of the operations described in the embodiments of the present invention may be changed. Some components or features of any embodiment may be included in another embodiment or replaced with the component and the feature corresponding to another embodiment. It is apparent that the claims that are not expressly cited in the claims are combined to form an embodiment or be included in a new claim by an amendment after the application.

The embodiments of the present invention may be implemented by hardware, firmware, software, or combinations thereof. In the case of implementation by hardware, according to hardware implementation, the exemplary embodiment described herein may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

In the case of implementation by firmware or software, the embodiment of the present invention may be implemented in the form of a module, a procedure, a function, and the like to perform the functions or operations described above. A software code may be stored in the memory and executed by the processor. The memory may be positioned inside or outside the processor and may transmit and receive data to/from the processor by already various means.

It is apparent to those skilled in the art that the present invention may be embodied in other specific forms without departing from essential characteristics of the present invention. Accordingly, the aforementioned detailed description should not be construed as restrictive in all terms and should be exemplarily considered. The scope of the present invention should be determined by rational construing of the appended claims and all modifications within an equivalent scope of the present invention are included in the scope of the present invention.

### INDUSTRIAL APPLICABILITY

An example is applied to the 3GPP 5 generation (5G) system is described primarily, but it is possible to apply the RRC connection method to various wireless communication systems in addition to the 3GPP 5G system.

1. A method for processing a non-access stratum (NAS) message by an access and mobility management function (AMF) in a wireless communication system, the method comprising:
receiving, from a user equipment (UE), an uplink (UL) NAS transport message including an uplink message; and
when the uplink message is not successfully forwarded to a network function (NF), transmitting, to the UE, a first downlink (DL) NAS transport message including a cause indicating that the uplink message is not forwarded.

2. The method of claim 1, wherein the first DL NAS transport message includes a PDU session identifier (ID) for identifying a protocol data unit (PDU) session.

3. The method of claim 1, further comprising:
transmitting the uplink message to the NF,
wherein when a response to the uplink message is not received from the NF, it is determined that the uplink message is not successfully transported.

4. The method of claim 3, further comprising:
starting a timer when transmitting the uplink message to the NF,
wherein when the response to the uplink message is not received from the NF until the timer expires, it is determined that the uplink message is not successfully transported.

5. The method of claim 3, wherein when the UL NAS transport message includes an indication that the NF needs to provide the response to the uplink message, the AMF waits for the response to the uplink message from the NF.

6. The method of claim 1, wherein if it is determined that transportation of the uplink message to the NF is not required, the transportation of the uplink message to the NF is not attempted and it is determined that the uplink message is not successfully transported, and
wherein the reason why the transportation of the uplink message is not required includes a case where the NF is in a congestion state, a case where the NF does not normally operate, and a case where an appropriate NF for transporting the uplink message does not exist.

7. The method of claim 1, further comprising:
transmitting, to the UE, a second DL NAS transport message including a downlink message from the NF to the UE,
wherein if the downlink message includes an indication that the response to the downlink message is requested from the UE, the AMF encapsulates an indication that the UE needs to provide the response to the downlink message in the second DL NAS transport message.

8. The method of claim 7, wherein the uplink message is the response to the downlink message.

9. An access and mobility management function (AMF) apparatus for processing a non-access stratum (NAS) message in a wireless communication system, the AMF apparatus comprising:
a communication module transmitting and receiving a wired/wireless signal; and
a processor controlling the communication module,
wherein the processor is configured to
receive, from user equipment (UE), an uplink (UL) NAS transport message including an uplink message, and
when the uplink message is not successfully forwarded to a network function (NF), transmit, to the UE, a first downlink (DL) NAS transport message including a cause indicating that the uplink message is not forwarded.

10. The AMF apparatus of claim 9, wherein the first DL NAS transport message includes a PDU session identifier (ID) for identifying a protocol data unit (PDU) session.

11. The AMF apparatus of claim 9, wherein a second DL NAS transport message including a downlink message transmitted from the NF to the UE is transmitted to the UE, and
wherein if it is determined that the UE needs to provide a response to the downlink message from the downlink message, the AMF encapsulates an indication that the UE needs to provide the response to the downlink message in the second DL NAS transport message.

12. The AMF apparatus of claim 11, wherein the uplink message is the response to the downlink message.
